(19) United States
(12) Patent Application Publication
(10) Pub. No.: US 2010/0119879 A1
(43) Pub. Date: May 13, 2010

(54) METHODS AND APPARATUS FOR STIMULATING AND MANAGING POWER FROM MICROBIAL FUEL CELLS

(75) Inventors: Peter Riad Girguis, Medford, MA (US); Peter Carr Kauffman, Bainbridge Island, WA (US)

Correspondence Address: WOLF GREENFIELD & SACKS, P.C., 600 ATLANTIC AVENUE, BOSTON, MA, 02210-2206, US

(73) Assignee: PRESIDENT AND FELLOWS OF HARVARD COLLEGE, Cambridge, MA (US)

(21) Appl. No.: 12/311,165

(22) PCT Filed: Sep. 20, 2007
(86) PCT No.: PCT/US2007/020357

§ 371 Date: Jan. 14, 2010

Related U.S. Application Data
(60) Provisional application No. 60/845,921, filed on Sep. 20, 2006.
(60) Provisional application No. 60/914,025, filed on Apr. 25, 2007.
(60) Provisional application No. 60/914,108, filed on Apr. 26, 2007.

(51) Int. Cl. H01M 8/16

(52) U.S. Cl. 429/2

(57) ABSTRACT

Inventive aspects of the present disclosure generally relates to fuel cells and, in particular, to fuel cells that can use microorganisms (microbes) to oxidize fuel. Certain aspects are directed to fuel cells that operate at relatively elevated temperatures. Such temperatures, for example, can increase the metabolisms of the microorganisms within the fuel cell. The elevated temperatures may be achieved, for instance, by using a thermal insulator, such as a vacuum jacket. Microorganism metabolism may also be improved, in some aspects of the invention, by exposing the microorganisms to growth promoters such as fertilizer, nitrogen sources, biomass, etc. The microorganisms, in some embodiments of the invention, may be anaerobic or microaerophilic and can be obtained, for example, from the soil, compost, peat, sewage, bogs, wastewater, or other organic-rich matrices. Another inventive aspect relates to novel electrodes for use in fuel cells, such as microbial fuel cells. The electrode, in some cases, may be flexible and/or porous. In certain embodiments, the electrode may be treated, e.g., with acid and/or biomass, to improve performance. Such treatments may facilitate microorganism metabolism. Yet another inventive aspect relates to a proton exchange interface between an anode and a cathode in a fuel cell, such as a microbial fuel cell. The proton exchange interface may be designed to allow protons and/or gases to pass through, but, in some cases, minimizes or eliminates mixing between the anode and the cathode. Still another inventive aspect generally relates to an energy management system for use with such fuel cells, including microbial fuel cells. Yet another aspect relates to switching systems that allow a plurality of fuel cells (which may be housed in one vessel or separate vessels) to sustain net power output that is greater than the sum of the individual microbial fuel cells under constant load. In some cases, the energy management system can store and manage energy from the fuel cell such that conventional operating voltages may be provided to a variety of loads having various instantaneous and average power requirements. Other inventive aspects relate to techniques for forming such fuel cells and fuel cell components, techniques for using such fuel cells, systems involving such fuel cells, and the like:

### RELATED APPLICATIONS

This application claims the benefit of U.S. Provisional Patent Application Ser. No. 60/845,921, filed Aug. 20, 2006, entitled “High-performance Thermophilic Microbial Fuel Cell,” by Girguis, et al.; U.S. Provisional Patent Application Ser. No. 60/914,025, filed Apr. 25, 2007, entitled “Methods and Apparatus for Providing Power from Microbial Fuel Cells,” by Girguis, et al.; and U.S. Provisional Patent Application Ser. No. 60/914,108, filed Apr. 26, 2007, entitled “Methods and Apparatus for Stimulating and Managing Power from Microbial Fuel Cells,” by Girguis, et al. Each of these applications is incorporated herein by reference.

### FIELD OF DISCLOSURE

The present disclosure generally relates to fuel cells and, in particular, to microbial fuel cells.

### BACKGROUND

Microbial fuel cells are devices that generate electricity by harnessing the power of microbial metabolism. To date, microbial fuel cells have been tested and shown to produce power in a variety of environments, including laboratory cultures, sewage treatment plants, and terrestrial and marine sediments. Almost all of these prior systems produce comparable power, typically producing between 30 mW/m² and 150 mW/m² of electrode surface continuously (i.e., when operated under constant load). In nearly all these systems the potential between the anode and the cathode is 100 mV to 700 mV. This is attributable to the chemical condition used in these microbial fuel cells, usually an oxygen-rich cathode environment and an organic-rich anode environment. Investigators have typically focused on increasing current by increasing the available organic carbon, by stimulating the production of natural electron mediators to help shuttle electrons between the microbes and the anode, by retaining heat generated as a byproduct of catabolism, or by circulating fluids around the anode and cathode to increase substrate availability. Thus, improvements in microbial fuel cell design are needed.

### SUMMARY

The present disclosure generally relates to fuel cells, including microbial fuel cells. The subject matter of the present disclosure involves, in some cases, interrelated products, alternative solutions to a particular problem, and/or a plurality of different uses of one or more systems and/or articles.

In one aspect, the disclosure is an article. The article, in a first set of embodiments, includes a fuel cell that uses microorganisms to oxidize fuel, and a thermal insulator at least partially surrounding the fuel cell. In another set of embodiments, the article includes a fuel cell comprising an anode, a cathode, and an electrolyte, where the fuel cell has an operating temperature of at least about 30° C., and where the fuel cell is constructed and arranged to passively and/or actively control its operating temperature. The article, according to another set of embodiments, includes a fuel cell comprising a chamber containing microorganisms able to oxidize a fuel, where the fuel cell is constructed and arranged to passively retain heat produced by the microbes when the microbes oxidize the fuel such that the temperature of the chamber containing the microbes is at least about 30° C.

In one set of embodiments, the article includes a fuel cell comprising microorganisms able to oxidize a fuel when the microorganisms are exposed to a temperature of at least about 50° C. In another set of embodiments, the article includes a fuel cell that uses microorganisms to oxidize fuel, where the microorganisms are contained within a compartment containing an electrode, and where the fuel cell is able to produce power of at least about 0.5 W/m² or at least about 1 W/m² of the electrode surface.

The article, according to one set of embodiments, includes a fuel cell that uses microorganisms to oxidize fuel, where the fuel cell has a substantially spherical shape.

In yet another set of embodiments, the article includes a fuel cell comprising an anode compartment and a cathode compartment separated by a proton exchange interface comprising particles, for example, mineral particles such as quartz and/or zirconium. The article, in still another set of embodiments, includes a fuel cell comprising an anode compartment and a cathode compartment separated by an interface comprising particles having an average diameter of less than about 500 micrometers, for instance, having an average diameter of between about 50 micrometers and about 500 micrometers. The particles may be of natural and/or synthetic origin. In another set of embodiments, the article includes a fuel cell comprising an anode compartment and a cathode compartment separated by nonpolymeric and/or a non-integral proton exchange interface. In yet another set of embodiments, the article includes a fuel cell comprising an anode compartment and a cathode compartment separated by an interface that allows gaseous convection therethrough to occur but is not electrically conducting. In still another set of embodiments, the article includes a fuel cell comprising an anode compartment and a cathode compartment separated by one or more mesh screens.

The article, according to one set of embodiments, includes an anode compartment and a cathode compartment separated by an interface, where the anode compartment is hermetically sealed, e.g., from the cathode compartment. In some cases, continuity can be maintained through one or more ports, which may be regulated in some instances. In some cases, the anode compartment is in gaseous communication with the atmosphere via a conduit and in gaseous communication with the cathode compartment via the interface.

In one set of embodiments, the article comprises a fuel cell comprising an inoculum of soil. In another set of embodiments, the article includes a fuel cell comprising a population of anaerobic microorganisms. In still another set of embodiments, the article includes a fuel cell comprising microorganisms able to transfer electrons to a terminal electron acceptor that is not O₂.

In accordance with yet another set of embodiments, the article includes a fuel cell that uses microorganisms to oxidize fuel, where the fuel cell may comprise a flexible electrode comprising graphite, carbon fiber, or other conductive fabric or material.

In another set of embodiments, the article includes a fuel cell that uses microorganisms to oxidize fuel, where the fuel cell comprises an electrode comprising a non-conductive material and a conductive coating at least partially surrounding the non-conductive material. The article, according to yet another set of embodiments, includes a fuel cell that uses microorganisms to oxidize fuel; in some cases, the fuel cell comprises a flexible porous electrode. In one set of embodiments, the article includes a fuel cell that uses microorganisms to oxidize fuel, where the fuel cell comprises an electrode comprising a plurality of mesh screens.

The article, in accordance with still another set of embodiments, includes a fuel cell that uses microorganisms to oxidize fuel, where the fuel cell comprises an electrode comprising a metal and a conductive coating comprising graphite, and where the conductive coating at least partially surrounds the metal.

In one set of embodiments, the article includes a fuel cell comprising an anode and a cathode, where the anode comprises yeast, and the cathode comprises a noble metal. The article, according to another set of embodiments, includes a fuel cell comprising an anode and a cathode, where the anode comprises a nitrate and the cathode comprises a noble metal. In yet another set of embodiments, the article includes a fuel cell comprising an anode and a cathode, where the anode is exposed to yeast and other microorganisms that could contribute to power production, and the cathode comprises a noble metal. The article, according to still another set of embodiments, includes a fuel cell comprising an anode and a cathode, where the anode comprises an electrode exposed to small quantities of other oxidants such as nitrate to stimulate complex carbon breakdown for other microorganisms to contribute to power production, and the cathode comprises a noble metal.

In yet another set of embodiments, the article includes a fuel cell comprising a compartment containing an anode, where the compartment contains microorganisms and nanowires that form an electrical connection between at least some of the microorganisms and the anode. In some cases, an electrode within the compartment may promote the growth of the nanowires.

In one set of embodiments, the article includes a fuel cell comprising a first compartment containing an anode and a second compartment containing a cathode. The first compartment may contain an inoculum of soil containing a population of anaerobic microorganisms able to oxidize a fuel comprising biomass. In some cases, the first and second compartments are separated by a nonpolymeric proton exchange interface, and the anode compartment may be hermetically sealed and in gaseous communication with the atmosphere via a conduit and in gaseous communication with the cathode compartment via the nonpolymeric proton exchange interface.

Another aspect of the disclosure is directed to a method. In one set of embodiments, the method is a method of drawing power from a fuel cell that uses microorganisms to directly oxidize biomass.

The method, according to one set of embodiments, includes an act of oxidizing biomass in a fuel cell to heat the fuel cell to a temperature of at least about 50° C. In another set of embodiments, the method includes an act of passing fertilizer, lime, charcoal, and/or one or more free amino acids into a fuel cell that uses microorganisms to oxidize fuel.

In one set of embodiments, the method includes acts of painting and/or spraying a graphite-containing material on an electrode, and placing the electrode in a fuel cell. The method, in accordance with another set of embodiments, includes acts of exposing an electrode to phosphoric acid and/or sulfuric acid, removing the electrode from the acid, placing the electrode in a fuel cell, and drawing current from the fuel cell. In still another set of embodiments, the method includes acts of exposing an electrode to an acid for at least about 8 hours, removing the electrode from the acid, placing the electrode in a fuel cell, and drawing current from the fuel cell.

The method, in yet another set of embodiments, includes acts of exposing an electrode to a first biomass, and placing the electrode in a fuel cell constructed and arranged to oxidize a second biomass. In another set of embodiments, the method includes acts of at least partially oxidizing a biomass using a microorganism, exposing the at least partially oxidized biomass to an electrode, and placing the electrode in a fuel cell. The method, in still another set of embodiments, includes acts of exposing an electrode to a nitrate and/or methylamine, exposing the electrode to a noble metal, and placing the electrode in a fuel cell.

In one set of embodiments, the method includes an act of causing or stimulating microorganisms contained within a fuel cell to form pili or biological nanowires. In another set of embodiments, the method includes acts of providing a fuel cell comprising a compartment containing an electrode and microorganisms, and forming direct electrical connections between a plurality of the microorganisms and the electrode.

In another aspect, the present disclosure is directed to a method of making one or more of the embodiments described herein, for example, a microbial fuel cell. In another aspect, the present disclosure is directed to a method of using one or more of the embodiments described herein, for example, a microbial fuel cell.

Another embodiment is directed to a power converter for at least one microbial fuel cell, comprising: an input energy storage device to receive energy from a cathode and an anode of the at least one microbial fuel cell; and a switching circuit to couple at least one of the anode and cathode of the at least one microbial fuel cell to a primary winding of a transformer based at least in part on a voltage potential between the anode and the cathode of the at least one microbial fuel cell. Yet another embodiment is directed to a switching circuit that cycles between at least one of the anode and cathode of one microbial fuel cell to another anode and cathode of one microbial fuel cell at a rate sufficient to increase net power output by at least 25% up to or greater than 500%.

Another embodiment is directed to an energy management apparatus for at least one microbial fuel cell, the apparatus comprising: at least one first energy storage component to store first energy provided by the at least one microbial fuel cell; a comparator circuit, coupled to the at least one first energy storage component, to compare a first voltage across the at least one first energy storage component to a first set point, the comparator circuit configured to implement a hysteresis window defined by a first predetermined level above the first set point and a second predetermined level below the first set point, such that an output of the comparator circuit changes from a first logic state to a second logic state when the first voltage is at or above the first predetermined level, and the output of the comparator circuit changes from the second logic state to the first logic state when the first voltage is at or below the second predetermined level; a voltage conversion circuit, coupled to the comparator circuit, to convert the first voltage to a second voltage higher than the first voltage, the voltage conversion circuit being activated in response to the second logic state and deactivated in response to the first logic state; and at least one second energy storage component, coupled to the voltage conversion circuit, to store second energy provided by the second voltage, wherein the at least one second energy storage component provides output power to a load.

Another embodiment is directed to a power management method for at least one microbial fuel cell, comprising: intermittently coupling the at least one microbial fuel cell to a load that draws significant current from the at least one microbial fuel cell.

Another embodiment is directed to a power management apparatus for at least one microbial fuel cell, the apparatus comprising: at least one input energy storage device to receive first energy from a cathode and an anode of the at least one microbial fuel cell; and a switching circuit to intermittently couple the anode and/or the cathode of the at least one microbial fuel cell to a load based at least in part on a voltage potential between the anode and the cathode of the at least one microbial fuel cell.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic diagram showing the reactions of a fuel cell of one embodiment of the present disclosure.

FIG. 2 shows a microbial fuel cell, according to another embodiment of the disclosure.

FIG. 3 shows another microbial fuel cell, according to another embodiment of the present disclosure.

FIG. 4 shows another microbial fuel cell, according to yet another embodiment of the present disclosure.

FIG. 5 is a block diagram illustrating an energy management apparatus, according to one embodiment of the present disclosure.

FIG. 6 is a block diagram illustrating an energy management apparatus for use with a microprocessor, according to one embodiment of the present disclosure.

FIG. 7 is a detailed circuit schematic of an energy management apparatus similar to that shown in FIG. 6, according to another embodiment of the present disclosure.

FIG. 8 is a detailed circuit schematic of an energy management apparatus including a self-starting power supply circuit, according to one embodiment of the present disclosure.

FIG. 9 is a graph illustrating plots of microbial fuel cell power output over time and a charge rate of one or more energy storage components to evaluate an exemplary time period in which significant power is drawn from the fuel cell, according to one embodiment of the present disclosure.

FIG. 10 is a graph showing comparative plots demonstrating the effectiveness of load balancing, or sequential loading of multiple microbial fuel cells, according to one embodiment of the present disclosure.

FIG. 11 is a detailed circuit schematic of a timing circuit to implement load balancing of multiple microbial fuel cells, according to one embodiment of the present disclosure.

### DETAILED DESCRIPTION

The present disclosure generally relates to fuel cells and, in particular, to fuel cells that can use microorganisms to oxidize fuel. Certain aspects of the disclosure are directed to fuel cells that operate at relatively elevated temperatures. Such temperatures, for example, can increase the metabolisms of the microorganisms within the fuel cell. The elevated temperatures may be achieved, for instance, by using a thermal insulator, such as a vacuum jacket. Microorganism metabolism may also be improved, in some aspects of the disclosure, by exposing the microorganisms to growth promoters such as fertilizer, nitrogen sources, biomass, etc. The microorganisms, in some embodiments of the disclosure, may be anaerobic or microaerophilic and can be obtained, for example, from the soil, compost, peat, sewage, bogs, wastewater, or other organic-rich matrices. In one embodiment, the system stimulates and/or sustains microorganisms that are able to form direct electrical connections with the electrode, e.g., by forming pili or biological nanowires. Another aspect of the disclosure relates to novel electrodes for use in fuel cells, such as microbial fuel cells. The electrode, in some cases, may be flexible and/or porous. In certain embodiments, the electrode may be treated, e.g., with acid and/or biomass, to improve performance. Such treatments may facilitate microorganism metabolism. Yet another aspect of the disclosure relates to a proton exchange interface between an anode and a cathode in a fuel cell, such as a microbial fuel cell. The proton exchange interface may be designed to allow protons and/or gases to pass through, but, in some cases, minimizes or eliminates mixing between the anode and the cathode. In one set of embodiments, the proton exchange interface contains particles (e.g., mineral particles such as sand, polymeric particles, or other electrically insulating particles), optionally held by mesh filters. In some cases, the proton exchange interface contains synthetic materials or particles, e.g. polymeric or glass or zirconium beads having an average diameter of about 500 micrometers. In certain instances, such particles may be readily packed into a relatively high density bead bed. Still another aspect of the disclosure generally relates to power converters for use with such fuel cells, including microbial fuel cells. Yet another aspect relates to switching systems that allow a plurality of fuel cells (which may be housed in one vessel or separate vessels) to sustain net power output that is greater than the sum of the individual microbial fuel cells under constant load. In some cases, the power converter can store energy such that relatively high amounts of power can be produced as needed, even in embodiments where a low amount of power is initially produced from the fuel cell. Other aspects of the disclosure relate to techniques for forming such fuel cells and fuel cell components, techniques for using such fuel cells, systems involving such fuel cells, and the like.

Various aspects of the disclosure are generally directed to a fuel cell or other electrochemical devices that use similar operating principles, for example, other electrochemical devices that are able to oxidize fuel to produce electrons. A fuel cell is a device that converts fuel to electrical energy without combustion of the fuel (although a fuel cell could be used in conjunction with a device deriving energy from combustion of the same fuel; most fuel cells do not). A typical fuel cell includes two electrodes, an anode and a cathode, an electrolyte in contact with both the anode and cathode, and an electrical circuit connecting the anode and the cathode from which power created by the device is drawn. The anode and the cathode are typically contained within separate compartments, which may be separated by an interface or a barrier. In some cases, the fuel cell may contain a plurality of anodes and/or cathodes, e.g., in the same or different compartments, which may be operated in series and/or in parallel.

In typical operation, an oxidant (e.g., oxygen, or the oxygen found in the air) is provided to a cathode of a fuel cell where it is reduced, e.g., to form water, while a fuel in the anode is oxidized, e.g., to produce CO₂, H⁺, and/or electrons. The electrons may be removed from the anode by a current collector, or other component of an electrical circuit, which results in an electrical current. The overall reaction is energetically favorable, i.e., the reaction gives up energy in the form of energy or power driving electrons from the anode, through electrical circuitry, to the cathode. This energy can be captured for essentially any purpose, e.g., for immediate use and/or for storage for later use.

The fuel cell may be fabricated from any suitable material. For example, in one set of embodiments, the fuel cell, or a portion thereof, such as an anode compartment, may be fabricated from non-conductive materials, for instance, from any polymer such as polyvinyl chloride, polyethylene, polypropylene, or polyethylene terephthalate. In another set of embodiments, the fuel cell (or portion thereof) may be formed from thermally insulative and/or non-conductive materials such as ceramics, glass, wood, and/or metals that may or may not be coated with thermal or electrical insulators, e.g. Teflon-coated aluminum, polymeric-coated steel, glass-lined stainless steel, etc. As discussed in detail below, in some embodiments of the disclosure, thermal insulators are useful for the management or retention of heat within the fuel cell, which may lead to higher microbial metabolism or efficiency, and/or higher power output.

In some aspects of the disclosure, the fuel cell is a microbial fuel cell (or “MFC”), i.e., the fuel cell uses microorganisms to converts fuel to electrical energy without combustion of the fuel, typically via an oxidation process. In one set of embodiments, the microbial fuel cell contains an anode and a cathode, each within different compartments. The cathode may be placed in a compartment with an abundance of oxygen (i.e. an aerobic environment), and/or in the presence of a soluble oxidant such as nitrate, sulfate, iron oxide, or manganese oxide, while the anode may be placed in a second compartment having an environment that is deficient in oxygen (i.e., an anaerobic environment), and/or other oxidants including, but not limited to, soluble oxidants such as nitrate, sulfate, iron oxide, manganese oxide, etc. In one embodiment, the anode contains a percentage of oxygen that is less than atmospheric oxygen, i.e., less than about 21% by total volume. For example, oxygen may be present in the second compartment at a percentage of less than about 18%, less than about 15%, or less than about 10% by volume. In another embodiment, the anode does not contain sufficient oxygen to completely oxidize any fuel present within the anode compartment, e.g., enough oxygen to stoichiometrically combust the fuel within the anode compartment to form fully oxidized species such as CO₂, H₂O, NO₂, SO₂, etc. For instance, the anode compartment may contain less than the stoichiometric amount of oxygen needed to oxidize the available fuel.

Typically, the fuel in a microbial fuel cell is a carbon-containing fuel, and is often organically based. For example, the fuel may include biological compounds such as sugars, fats, connective or structural tissues, and/or proteins. In some cases; the fuel comprises biomass, i.e.; matter derived from living biological organisms. “Biomass,” as used herein, may arise from plants or animals. For example, plants such as switch grass, hemp, corn, poplar; willow, or sugarcane may be used as a fuel source in a fuel cell of the present disclosure. The entire plant, or a portion of a plant, may be used as the fuel source, depending on the type of plant. As another example, biomass may be derived from animals, for instance, animal waste or animal feces, including human sewage (which may be used raw, or after some treatment). Still other non-limiting examples of biomass include food scraps, lawn and garden clippings, dog feces, bird feces, composted livestock waste, untreated poultry waste, etc. The biomass need not be precisely defined. In some cases, the biomass does not necessarily exclude fossil fuels such as oil, petroleum, coal, etc., which are not derived from recently living biological organisms, nor does it exclude refined or processed materials such as kerosene or gasoline. For example, biomass used as fuel in various fuel cells of the present disclosure may be derived from a compost pile, a manure pile, a septic tank, a sewage treatment facility, etc., and/or from naturally organic-rich environments such as estuaries, peat bogs, methane bogs, riverbeds, plant litter, etc.

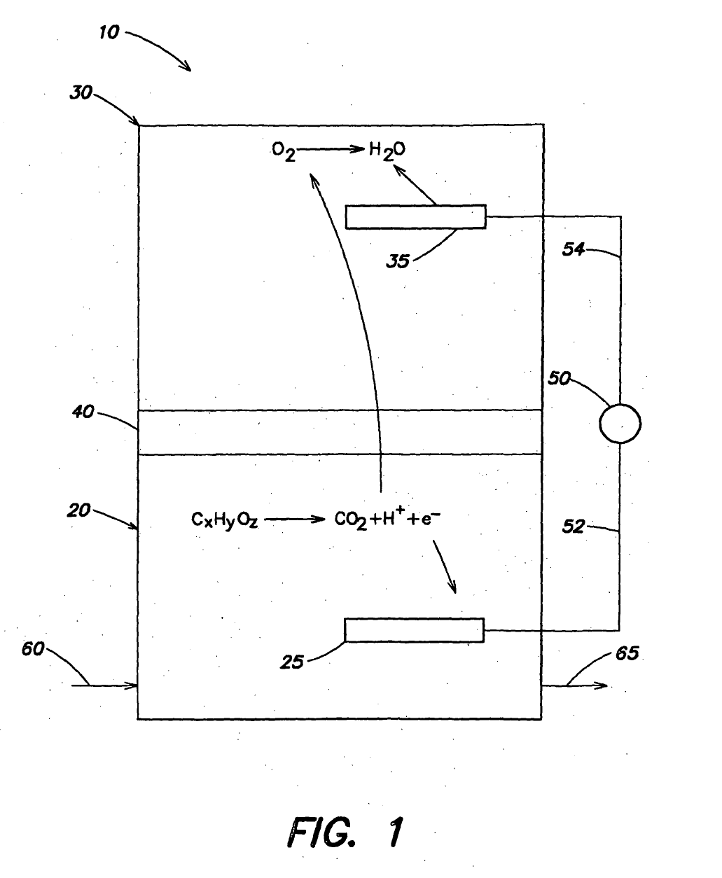

A schematic view of one fuel cell of the disclosure is shown in FIG. 1. In this example, fuel cell 10 comprises anode compartment 20 and cathode compartment 30, separated by interface 40. Within anode compartment 20 is anode 25, and within cathode compartment 30 is cathode 35. Electrical connections 52 and 54 from each of these respective electrodes are then connected to load 50, e.g. a light, a motor, an energy storage device, a switching circuit, or the like. The potential between anode 25 and cathode 35 results in net electron flow towards the cathode 35 and through the load. Charge balance and continuity can be maintained by proton diffusion and/or transport from cathode chamber 30 to anode chamber 20. Anode compartment 20 may contain microorganisms able to directly oxidize biomass or other carbon-containing fuels to produce hydrogen and/or electrons, (represented schematically as CₓH_{y}O_{z}->CO₂+H⁺+e⁻, where CₓH_{y}O_{z} need not be precisely defined, but represents biomass or other carbon-containing fuels). In some cases, anode compartment 20 is an anaerobic environment deficient in oxygen gas (O₂) or other dissolved oxidants such as nitrate or sulfate, and electrons produced during oxidation of fuel by the microorganisms are not passed to oxygen or other endogenous oxidants, as a terminal electron acceptor (e.g., to produce H₂O), but instead can be collected by anode 25 as electricity.

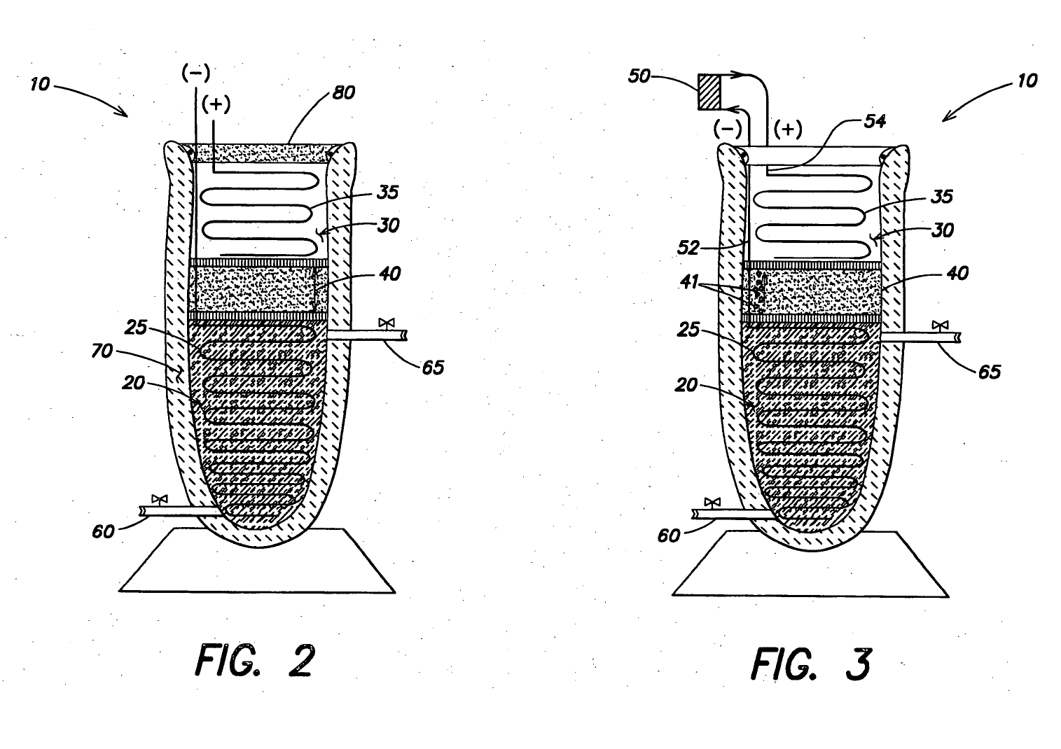

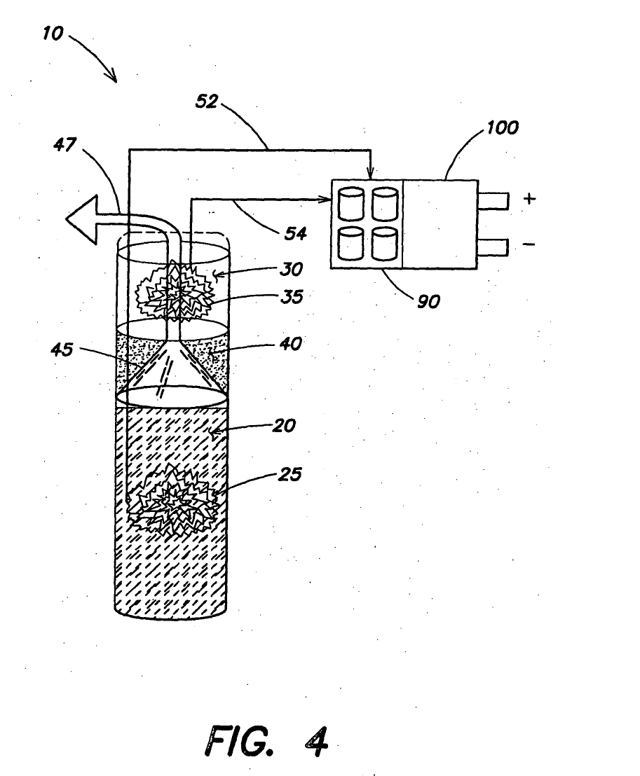

The fuel may be present within the anode compartment before the fuel cell is used to produce electricity (a “closed” fuel cell), or added during operation of the fuel cell to produce electricity (an “open” fuel cell). FIG. 2 shows an example of a closed fuel cell, where a fixed volume or concentration of fuel is added to the anode and/or cathode compartment, and the electrons are collected by anode 25 as the microorganisms oxidize the fuel to various degrees of completion. The electrons harnessed by anode 25 can travel towards cathode 35, and through a load, as previously described. FIG. 3 shows an example of an open fuel cell, where fuel is added to the fuel cell through inlet 60, and optionally, waste is removed through outlet 65. The electrons collected by anode 25 as the microorganisms oxidize fuel (residual and/or fresh) may be harnessed to produce power, as mentioned above.

Hydrogen produced during oxidation of the biomass or other carbon-containing fuel by the microorganisms in the fuel cell (which may be present as protons, H⁺, and/or hydrogen gas, H₂), may be transported across interface 40 from anode compartment 20, where the hydrogen is produced, to cathode compartment 30 (see FIG. 2). In some cases, interface 40 is a proton exchange interface that allows hydrogen to be transported across, but does not allow substantial transport of other dissolved compounds to occur, e.g., the interface may limit the diffusion of reduced or oxidized chemical compounds between the anode compartment 20 and the cathode compartment 30 that can have a deleterious effect on fuel cell performance. In some cases, the proton exchange barrier may prevent or at least inhibit oxygen gas from diffusing into the anode compartment, while allowing hydrogen to move between the compartments, thereby causing the anode compartment to become anaerobic (deficient in oxygen) during operation of the fuel cell. In one embodiment, the proton exchange barrier includes a synthetic polymer membrane that separates the two compartments. In other embodiments, however, the proton exchange interface may contain particles (e.g., of sand), for instance, forming a particulate bed, optionally held by mesh filters, such as those discussed below.

Within cathode compartment 30, hydrogen from anode compartment 20 may enter from interface 40 to be oxidized to form water, e.g., by being combined with electrons from cathode 35 (thereby completing the electrical circuit with anode compartment 30; see FIG. 2) and O₂, e.g., from the air, i.e., O₂+H⁺+e⁻->H₂O. Cathode compartment 30 may thus contain an aerobic environment, and in some cases, cathode 30 is open to the atmosphere and/or is in fluidic communication with the atmosphere, e.g., through one or more conduits. In some embodiments, hydrogen may also be captured (e.g., via diffusion) into a gas collector overlying cathode compartment 30.

It should be noted that the chemical reactions shown in FIG. 1 are for illustrative purposes only, and are not stoichiometrically balanced; the actual reactions, of course, will depend on factors such as the type of fuel used, the operating temperature, the types of microorganisms involved, and the like. For instance, as discussed below, in some embodiments of the disclosure, microorganisms may be used within the fuel cell that are able to transfer electrons to any suitable non-oxygen species, such as a metal, a mineral, ammonia, a nitrate, etc.

Microorganisms present within one or both compartments may be able to grow on the respective electrodes. For example, microorganisms in anode compartment 20 (which may be run in an anaerobic condition) may metabolize biomass or other carbon-containing fuel and transfer electrons produced during this process to the anode 25. Because of the difference in electrical potential between the anode compartment and the cathode compartment, the electrons move towards cathode 35 through load 50. The microorganisms within the anode compartment thus are able to utilize the anode as a terminal electron acceptor, thereby producing electrical current. In some cases, the potential created between the anode compartment and the cathode compartment may be between about 0.1 V and about 1 V, or between about 0.2 V and about 0.7 V.

Another example fuel cell of the present disclosure is shown in FIG. 2. In this figure, fuel cell 10 is surrounded by a vacuum chamber 70, which acts as a thermal insulator. Vacuum chamber 70 may be, for example glass-walled. The vacuum chamber may completely surround the fuel cell, or, in some cases such as shown in FIG. 2, may only partially surround fuel cell 10. As shown in FIG. 2, the fuel cell is capped by an air-permeable membrane 80, e.g., gortex, which may be held in a plastic frame. In some cases, the membrane is water-resistant. Such a “cap” may be useful, for example, to allow access to the fuel cell, e.g., for maintenance purposes, while allowing oxygen to diffuse into cathode compartment 30 in some cases. Within the fuel cell are anode compartment 20 and cathode compartment 30, separated by interface 40. An anode 25, such as a porous conductive sheet, is present within anode compartment 20, while a cathode 35, which may also be a porous conductive sheet, is present within cathode compartment 30. The anode is the negative electrode and the cathode is the positive electrode. Anode compartment 20 may contain a fuel, for example an organic-rich fuel or biomass, which can be oxidized by microorganisms within anode compartment 20 to produce hydrogen and/or electrons. As shown in FIG. 3, fuel may be added to anode compartment 20 through inlet 60 and waste removed via outlet 65. Interface 40, in this example, includes particles (e.g., sand), capped by inert porous frits. The interface may allow protons and/or gaseous transport to occur therethrough (e.g., H₂, CO₂, etc.), but may minimize or eliminate mixing between the anode and the cathode, e.g., reducing or eliminating the transport of reduced or oxidized compounds. Instead, the electrons flow through the anode and the cathode, completing a circuit, which can be used, e.g., to be stored or used to perform work.

A similar fuel cell is shown in FIG. 3. In this example, anode compartment 20 may contain an anaerobic environment. Electrons produced by microorganisms in the anode compartment 20 as a fuel is oxidized are collected by anode 25, while gases produced by the microorganisms, such as H₂ or CO₂, are able to pass through interface 40, shown in FIG. 3 as “bubbles” 41. The bubbles are for illustrative purposes only; in reality, gases may travel through a packed bed of sand without being in discrete bubbles. In contrast, electrons flow through anode 25, then to load 50 via wire 52 (insulated from cathode compartment 30), then to cathode 35 via wire 54.

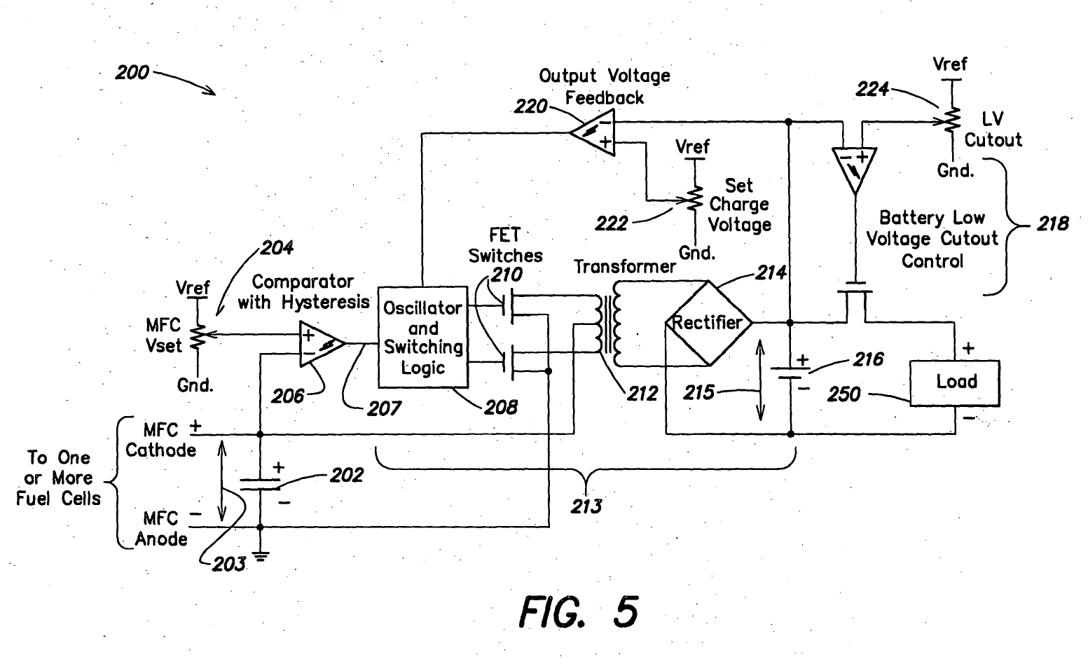

Still another example fuel cell of the present disclosure is shown in FIG. 4. In this figure, fuel cell 10 includes an anode compartment 20 (containing an anode 25) and a cathode compartment 30 (containing a cathode 35), separated by interface 40. Anode 30 may contain a fuel, for example, biomass or other carbon-containing fuel. A collector 45 adjacent to anode compartment 20 and contained within interface 40, collects gases produced in anode compartment 20 (e.g., H₂ or CO₂), and pass the gases through proton exchange interface 40 to be expelled from fuel cell 10 via conduit 47. Wires 52 and 54 connect anode 25 and cathode 35, respectively, to a capacitor array 90, which can store electrical energy for later use. For instance, as discussed below, the electrical energy may be converted, via DC-DC converter 100, to modulate voltage and/or current, and/or store power as needed, even in cases where a low amount of power is initially produced from the fuel cell.

As mentioned, various embodiments of the disclosure use microorganisms able to oxidize fuel to produce electricity. Such microorganisms may be aerobic and/or anaerobic, and may include bacteria, fungi, archaea, protists, etc. Typically the microorganisms are unicellular, although in some cases, the microorganisms may include multicellular lower organisms. The microorganisms are usually, but not always, of microscopic dimensions, i.e., being too small to be seen by the human eye. In some cases, the microorganisms are mesophiles, thermophiles, or extremophiles, i.e., the microorganisms have maximal growth rates at warm to hot temperatures, about 30° C. to about 50° C., about 50° C. to about 90° C., or greater than about 90° C., respectively.

The microorganisms used in the fuel cell may be a monoculture, or in some cases, a diverse culture or population of phylotypes. The term “phylotype,” as used herein, is used to describe an organism whose genetic sequence differs from known species by less than approximately 2% or less than approximately 1% of its base pairs. For example, the microorganisms contained within a fuel cell that are able to oxidize a fuel to produce electricity may comprise at least 10 phylotypes, at least 30 phylotypes, at least 100 phylotypes, at least 300 phylotypes, at least 1,000 phylotypes, etc. of various microorganisms, which may not all necessarily be fully characterized for operation of the fuel cell. The microorganisms may be naturally occurring, genetically engineered, and/or selected via natural selection processes. For example, in one embodiment, a population of microorganisms used as an inoculum in a fuel cell of the disclosure may be taken from another microbial fuel cell, which may also be a microbial fuel cell of the disclosure; repetition of this process may result in natural selection of a population of microorganisms having desirable characteristics, such as the ability to rapidly oxidize specific types of fuel.

The microorganisms may be used to directly oxidize a fuel to produce electricity in various embodiments of the disclosure, i.e., the microorganisms that oxidize the fuel in the fuel cell produce electrons during the oxidation process, which are then directly collected (e.g., by an anode) to produce electricity. In contrast, in many prior art fuel cells, the microorganisms do not directly produce the electrons and the electricity ultimately produced by the fuel cell, but instead, the microorganisms are used to produce an intermediate product in a first chamber, which is then moved to a second chamber to be oxidized to produce electrons. Accordingly, the present disclosure allows for a fuel cell that uses one or more microorganisms (for instance, naturally occurring and/or genetically engineered phylotypes, etc.) to directly oxidize biomass or other carbon-containing fuels to produce electricity, for instance, in a that results in high net efficiency of power production per unit fuel oxidized. In some cases, the microorganisms may be a community of microorganisms, and in certain instances, not all of the community of microorganisms need be individually determined.

In some embodiments, virtually any chamber able to contain biomass can be used as a fuel cell. For example, in one embodiment of the disclosure, the anode compartment is a septic tank, e.g., a residential septic tank. Electrodes, such as those described herein, may be inserted into the septic tank such that the septic tank is able to function as an anode compartment of a fuel cell (often without impeding its function as a septic tank). A cathode compartment may also be added to the septic tank and separated with an interface, such as those described below, and the anode and cathode compartments may be connected via a suitable electrical connection, thereby producing a fuel cell. As another example, a sewage treatment plant, or a portion of such a plant (for example, a sedimentation tank), may be used as an anode compartment for a fuel cell of the present disclosure.

In some embodiments, the fuel cell is an “open” fuel cell, i.e., fuel is added to the fuel cell during operation of the fuel cell to produce electricity (see, e.g., FIG. 3). For example, a fuel cell may contain an anode compartment that contains an inlet to introduce fuel, and optionally an outlet. In some cases, fuel may be continuously fed to the anode compartment during operation of the fuel cell. Those of ordinary skill in the art will know of techniques for operating a bioreactor as a continuous process, e.g., using pumps, valves, sensors, conduits, and the like. In other embodiments, however, the fuel cell is a “closed” fuel cell, i.e., no fuel is added to the fuel cell during operation of the fuel cell. In some instances, however, fuel may be added before operation of the fuel cell, and/or between electricity-producing runs using the fuel cell. For example, fuel can be added during assembly of the fuel cell, and in some cases, hermetically sealed within the anode compartment prior to operation of the fuel cell. In some cases, a closed fuel cell may be contained within another vessel. A closed system, in some cases, may be relatively portable and/or scalable. A closed system may be run until self-passivation occurs, e.g., when the anode and the cathode have substantially the same potential, such that no electrons can be collected to do work by the fuel cell. Such passivation may occur, for instance, when reduced fluids or gases from the anode compartment also enter the cathode compartment, e.g., via leakage, diffusion, or the like. However, in some cases, a closed system may be stopped and recharged, e.g., with additional fuel and/or the system may be refreshed by electrical or mechanical manipulation of the fuel, matrix, and/or electrodes, etc., before resuming operation.

In some cases, the microorganism population within a fuel cell of the present disclosure is one that is not well-defined or characterized. In contrast, many prior art microbial fuel cells rely on a key microorganism species for operation. In some embodiments, there may be a population of various microorganisms contained within the fuel cell that are able to oxidize a biomass or other carbon-containing fuels to produce electricity, and the species of microorganisms forming such populations need not be explicitly identified or characterized. There may be at least 10 species, at least 30 species, at least 100 species, at least 300 species, at least 1,000 species, etc. of various microorganisms within a fuel cell of the present disclosure that are able to, in whole or in part, directly oxidize biomass or other carbon-containing fuels to produce electricity. For instance, in some cases, two or more species of microorganisms together define a reaction pathway where biomass or other carbon-containing fuels is oxidized to produce electricity. As mentioned, the microorganisms may be naturally occurring, genetically engineered, and/or selected via natural selection processes.

As a specific, non-limiting example, the microorganism population may be one that arises from a sample of soil, and may be used in the fuel cell, e.g., as an inoculum, without identifying or characterizing the population of microorganisms. Thus, for example, prior to operation of a fuel cell of the present disclosure, an inoculum of soil may be added, e.g., to an anode compartment. Any soil sample may be used, and the soil sample may be used without refinement or alteration in some cases. For instance, the soil sample may be one from any depth of soil (e.g., surface soil, or from subsoil regions, e.g., from at least 3 inches deep, at least 6 inches deep, at least 9 inches, at least 1 foot, etc.), and may be taken from any suitable location, for example, from Massachusetts or California, or any other suitable geographic locale.

In some cases, the population of microorganisms (even if not well-characterized), may change during operation of the fuel cell. For example, the population of the microorganisms and/or their relative ratios may change, for instance, due to factors such as the type of fuel being delivered to the fuel cell, the operating temperature of the fuel cell, the oxygen concentration within the fuel cell, the various rates of growth of the microorganisms, growth factors in the environment surrounding the microorganisms, etc. In some cases, the microorganisms may be brought to the fuel cell with the biomass. As an example, biomass such as sewage, compost, manure, or the like may contain suitable microorganisms for operation of a fuel cell of the present disclosure.

In one set of embodiments, at least some of the microorganisms within the fuel cell able to oxidize a biomass or other carbon-containing fuels to produce electricity are anaerobic, i.e., the microorganisms do not require oxygen for growth, although the microorganisms, in some cases, can tolerate the presence of oxygen (aerotolerant), or even use oxygen for growth, when oxygen is present (facultative anaerobes). Those of ordinary skill in the art will be able to identify a microorganism as an aerobe or an anaerobe, e.g., by culturing the microorganism in the presence and in the absence of oxygen (or in a reduced concentration of ambient oxygen). Such anaerobic microorganisms are often found in lower regions of soil (where there is a reduced amount of oxygen present), and generally are able to oxidize or metabolize a fuel in without using oxygen as a terminal electron acceptor. A terminal electron acceptor is generally a chemical species, such as oxygen (O₂), that is reduced upon acceptance of electrons to produce a species that is not further reduced by acceptance of electrons; for instance, O₂ may be reduced to form H₂O.

As specific examples, a microorganism may be able to transfer electrons to a non-oxygen (O₂) species that is able to act as a terminal electron acceptor. For instance, the terminal electron acceptor may be a metal such as iron or manganese, ammonia, a nitrate, a nitrite, sulfur, a sulfate, a selenate, an arsenate, or the like. Note that the terminal electron acceptor may comprise bound oxygen in some cases (for example, as in a nitrate or a nitrite) but the terminal electron acceptor is not oxygen, i.e., O₂. As discussed below, in certain embodiments of the present disclosure, an electrode may function as a terminal electron acceptor, and the electrons collected by the electrode may be collected as electricity. In some cases, the electrode may contain an oxidizable and/or a conductive species, which may facilitate electron collection.

The fuel for the fuel cell may be any suitable carbon-containing fuel, as previously discussed, and is often organically based. For example, the fuel may be a biomass. The fuel may be solid, semi-solid, liquid, fluid, etc. The microorganisms may oxidize the fuel to produce CO₂ and/or hydrogen (e.g., as protons and/or hydrogen gas), releasing electrons in the process. In some embodiments, the recipient of these electrons (or the terminal electron acceptor) is a component of an electrode, i.e., electrons produced by the microorganism during oxidation of a fuel are expelled from the interior of the cell to an electrode, either directly or indirectly, which are then harnessed, e.g., for power. For example, an anaerobic microorganism may oxidize biomass or other carbon-containing fuel (represented by the formula CₓH_{y}O_{z}) to form CO₂ and/or other species (e.g., fully oxidized species, such as H₂O, NO₂, SO₂, etc.), releasing electrons during the oxidation process, which are then reacted with the terminal electron acceptor. In some cases, the terminal electron acceptor may be present on the electrode, e.g., to facilitate collection of the electrons into an electrical circuit.

In certain embodiments of the disclosure, a component of the electrode may serve to stimulate the electrical conduction between the microorganisms and the electrode. This may occur, at least in part, through pili, or other direct connections between the microorganisms and the electrode within the compartment containing the microorganisms and the electrode. In some cases, certain microorganisms may be induced, e.g., by an anodic environment and/or action of the device (e.g., electronics within the device) to form various cellular features such as pili. These pili may form direct electronic communication between the microorganisms and the electrode in some embodiments of the disclosure (such direct electronic communication may occur over a plurality of pili, in some cases). Without wishing to be bound by any theory, it is believed that in some cases, the device may promote the growth of microorganisms that produce such pili and/or nanowires that enhance electron transport from the microorganisms, and thus, the device may enhance metabolism of those microorganisms and/or net power production. In some cases, the microorganisms may be induced to form pili via suitable treatment of an electrode, e.g., chemical treatments, as discussed below.

In another set of embodiments, the electrical conditions of the anode compartment are such that conductive pathways may be formed, e.g., biological nanowires, from proteins, lipoproteins, metals, metal ions, or any composition comprising organic and/or inorganic compounds that are present within the anode compartment or synthesized by the microorganisms present. In some cases, these conductive nanowires may have a diameter of less than about 1 micrometer. Without wishing to be bound by any theory, such conductive pathways may be created due to the electric field gradients created by the anode within the anode compartment, the treatment of the anode (e.g., as described herein), and/or the device as a whole. Such pathway formation within the anode compartment may be analogous to dendritic formation within the electrodes of a battery, and/or may facilitate electron transfer to the anode, which may improve net power production by the device.

In one aspect of the disclosure, microorganism growth within a fuel cell of the present disclosure may be enhanced by the addition of suitable growth agents, such as fertilizer or other nitrogen sources, to the fuel cell. The growth agent may be added to the fuel cell at any suitable time, for example, sequentially and/or simultaneously with the addition of fuel to the fuel cell. The growth agent may be any species able to increase metabolism of a fuel by the microorganisms during operation of the fuel cell, relative to their growth in the absence of the species, and the growth agent may include one, or a plurality, of compounds. The growth agent need not be precisely defined. For example, in some cases, the growth agent may be derived from biomass, for example, animal waste or animal manure (e.g., horse manure, poultry, etc).

As an example, in one set of embodiments, agricultural fertilizer is added to the fuel cell. The fertilizer may contain elements such as nitrogen, phosphorous, and/or potassium (in any suitable compound), which may promote microbial growth. Other examples of elements that may be contained within the fertilizer include, but are not limited to, calcium, sulfur, magnesium, boron, chlorine, manganese, iron, zinc, copper, molybdenum, or the like. In some cases, the fertilizer is a commercially available fertilizer. For example, the fertilizer used in the fuel cell may be plant fertilizer, which is often having a “grade” that describes the percentage amounts of nitrogen, phosphorous, and potassium that is present within the fertilizer. For instance, a fertilizer may have a grade of at least 3-3-2, i.e., comprising at least 3% nitrogen, at least 3% phosphorous, and at least 2% potassium. In one embodiment, the fertilizer comprises substantially equal parts of nitrogen, phosphorous, and potassium. However, the fertilizer is not required to have all three of nitrogen, phosphorous, and potassium.

As another example of a growth agent, a nitrogen source, such as ammonia, a nitrate (e.g., sodium nitrate, potassium nitrate, etc.), or a nitrite (e.g., sodium nitrite, potassium nitrite, etc.) may be passed into the fuel cell as a growth agent, where the nitrogen source is any source of nitrogen that can be metabolized by microorganisms contained within the fuel cell. Nitrogen itself (i.e., N₂) may be a nitrogen source, if the microorganisms are anaerobic and contain the appropriate pathways and enzymes (e.g., using nitrogenases) in sufficient quantities for the nitrogen to be useful as a growth agent. In some embodiments, as mentioned, a fertilizer may include a nitrogen source. In another embodiment, one or more free amino acids are passed into the fuel cell. Examples of amino acids that may be provided to the fuel cell include, but are not limited to, isoleucine, leucine, lysine, methionine, phenylalanine, threonine, tryptophan, and valine, arginine, cysteine, glycine, glutamine, or tyrosine. Such free amino acids may also be nitrogen sources.

Other materials may also be passed into the fuel cell, e.g. as growth agents, or to control conditions within the fuel cell, for instance, to create conditions conducive for microorganism oxidation of a fuel to occur. For example, electrically conductive substrates may be supplied, e.g., to enhance electrical conduction between the microorganisms and the electrodes, or species able to control pH, e.g., alkaline agents and/or acidification agents, may be supplied. Non-limiting examples of these include, but are not limited to, charcoal (e.g., activated charcoal) or lime.

Combinations of these and/or other materials are also contemplated. For example, in one embodiment, 1 part fuel having nearly equal parts nitrogen, phosphorous and potassium, 0.1 part of an alkaline agent such as lime, and 0.1 part of a electrically conductive substance such as activated charcoal may be used in a fuel cell of the present disclosure.

In some cases, the introduction of growth agent or other materials, such as species able to control pH, may be regulated using a control system. For example, the temperature, pH, electrical output, etc. of a fuel cell of the present disclosure may be determined, using suitable sensors, and used to control the introduction of such materials into the fuel cell. For instance, the pH of the anode compartment may be measured, and if too low, an alkaline agent such as lime may be added to the anode compartment.

Another aspect of the disclosure is generally related to the management of heat within the fuel cell. In some cases, the metabolic rate of the microorganisms is generally proportional to the temperature, i.e., by heating the microorganisms, higher metabolic rates, and higher fuel oxidation rates, may be achieved, which may lead to higher power output. The relationship between metabolic rate and temperature is often expressed as Q₁₀, which measures the rate increase for each 10° C. rise in temperature. For example, if the rate triples for each 10° C. rise, then the value of Q₁₀ is 3. In some cases, the metabolic rate of the microorganisms contained within a fuel cell of the present disclosure may be increased by 5-, 10-, or 16-fold by increasing the temperature by at least 10° C., and in some cases, up to 70° C. In some cases, substantial heat may be generated by the microorganisms during operation of the fuel cell. For example, the operating temperature of the compartment containing the cells may be raised to at least 30° C., at least 50° C., or at least 70° C.

In addition, the temperature of the compartment, in some embodiments, may be maintained within a fairly narrow temperature range. For instance, the temperature of the compartment may range between about ±1° C., about ±0.3° C., or about ±5° C. for at least about 4 weeks, at least about 8 weeks, or at least about 12 weeks. The temperature may be actively controlled, e.g., using sensors, control systems, heat elements, and the like; but in other cases, the temperature of the compartment may be regulated passively, i.e., the temperature is controlled within the device without the presence of sensors or actuators to control the temperature. As discussed below, the temperature may be controlled primarily by controlling the heat retention of the device. The temperature within the device may also be controlled, in some cases, by controlling the amount of fuel entering the device, e.g., the temperature can be raised by adding more fuel (or adding fuel more quickly), and lowered by not adding fuel (or adding fuel more slowly). In still another embodiment, the temperature may be controlled by controlling the amount of fertilizer, growth agent, nitrogen source, electrically conductor, alkaline agent and/or acidification agent, etc. that is introduced into the fuel cell. In yet another embodiment, a combination of these and/or other techniques may be used.

Additionally, relatively high power outputs may be produced by a fuel cell of the present disclosure in some cases. For example, the fuel cell is able to produce power of at least about 1 W/m² of electrode surface, at least about 1.6 W/m² of electrode surface, at least about 2.7 W/m² of electrode surface, or at least about 4.3 W/m² of electrode surface, etc. In some embodiments, the fuel cell may be heated, for example, internally or externally of the compartment containing the microorganisms. However, in some cases, there may be no active heating of the fuel cell, i.e., the fuel cell is constructed and arranged to passively control its operating temperature. Instead, as the microorganisms may produce heat during oxidation of the fuel, such heat may be retained to heat the compartment containing the microorganisms. For instance, in one embodiment, the temperature of the fuel cell, in an open fuel cell, was passively maintained at about 57° C. for about 3 months. In yet other embodiments, a combination of active and passive heating may be used.

For instance, in one set of embodiments, the fuel cell and/or a portion of the fuel cell, such as the compartment containing the microorganisms, may be at least partially surrounded by a thermal insulator. Substantially any thermal insulator may be used, for example, a foam (e.g., formed from polyurethane, polyisocyanurate, etc.), asbestos, a ceramic, fiberglass, or the like. In one set of embodiments, vacuum insulation may be used. For instance, the fuel cell may be surrounded by a vacuum flask, e.g., a double-walled flask. Examples of fuel cells with vacuum flasks are shown in FIGS. 2 and 3. In some cases, the thermal insulator may have an insulating efficiency of at least about 80%, at least about 90%, or at least about 95% at an operating temperature of the fuel cell of 50° C., where the insulating efficiency is defined as the amount of heat lost due to thermal radiation from the device.

In some embodiments, the fuel cell may have a shape that is directed to help retain heat within the fuel cell. For instance, the fuel cell may be constructed to have a substantially spherical shape, which may help to passively retain and use heat produced by the microorganisms and/or introduced externally to stimulate oxidation of the fuel. A spherical shape has a maximal volume and a minimal exposed surface area. Other shapes are also possible in other embodiments of the disclosure, for example, a cylindrical shape.

Another aspect of the disclosure is generally directed to an interface separating an anode compartment and a cathode compartment in a fuel cell. In one set of embodiments, the interface is a proton exchange interface, i.e., the interface allows protons and/or gases (e.g., H₂) to pass through, but does not substantially allow other chemical compounds to pass through, i.e., the proton exchange barrier is an insulator, and/or has a relatively high electrical resistance. For instance, the interface may be formed from materials having a resistivity of at least about 10¹ ohm m (Ω m), at least about 10³ ohm m, at least about 10⁵ ohm m, at least about 10⁸ ohm m, at least about 10¹⁰ ohm m, at least about 10¹¹ ohm m, at least about 10¹² ohm m, at least about 10¹³ ohm m, at least about 10¹⁴ ohm m, etc. Accordingly, the proton exchange barrier allows gases (e.g., produced by microorganisms oxidizing a fuel) to pass therethrough, while electrons are collected by the electrodes and stored or used to perform work.

In one set of embodiments, the proton exchange interface is a polymeric membrane. Examples of suitable proton exchange membranes include, but are not limited to, ionomeric polymers or polymeric electrolytes. Those of ordinary skill in the art will be familiar with proton exchange membranes, such as those used in proton exchange membrane fuel cells. However, in other embodiments, the proton exchange interface may be nonpolymeric. In some cases, the proton exchange interface is non-integral, i.e., the interface is not formed of a unitary sheet of material, such as a polymeric membrane. Such a non-integral interface may be useful, for instance, in allowing gases such as H₂ or CO₂ to escape from the anode compartment during operation of the fuel cell. In some cases, smaller particles may be used, since smaller particles may allow a thinner proton exchange interface by better separating the reduced and oxidized chemicals but allowing more rapid equilibration or migration of protons, which may thus improve power output.

For example, in one set of embodiments, the proton exchange interface comprises particles of an insulating material, such as quartz, silica, polymeric beads, zirconium beads, sand, etc. The insulating material may be manufactured and/or naturally occurring. Such materials may allow gaseous diffusion to occur therethrough, but prevent or at least inhibit electrical transport due to their insulative or nonconducting nature. The particles may be packed to form a packed bed, and the particles may have any suitable average diameter, for example, less than about 500 micrometers, or between about 150 and about 300 micrometers. The average diameter of the particles may be determined, for example, using a mesh screen, where the average diameter is the spacing in the mesh screen where about 50% of the particles are able to cross the mesh screen.

In some cases, the particles may be contained by one, two, or more mesh screens, which may separate the anode compartment and the cathode compartment. In some cases, the screens may be meshes having a spacing that substantially prevents particles contained by the screens from exiting. For instance, at least about 50%, at least about 70%, at least about 80%, at least about 90%, at least about 95%, etc. of the particles may be trapped by the screens. The mesh may comprise any suitable material, for example, a nonconductive material, such as glass, fiberglass, or a polymer. In some cases, the mesh may have an average spacing of less than about 10 mm, for instance, less than about 300 micrometers, less than about 200 micrometers, less than about 150 micrometers, between about 100 micrometers and about 5 mm, etc.

The proton exchange interface may have any suitable thickness, and the thickness may depend on the size of the anode and cathode compartments. For example, the proton exchange interface may have a thickness of between about 1 cm and about 50 cm, or between about 1 cm and about 10 cm. The thickness may be chosen, for instance, based on the nature or quality of the fuel and/or the microorganisms contained within the device, for instance, to allow sufficient proton exchange to occur while keeping the anode compartment sufficiently anaerobic or anoxic.

In one set of embodiments, the anode compartment may be hermetically sealed, such that the anode compartment is in fluidic or gaseous communication via the interface between the anode and the cathode, and/or via a conduit exposed to the atmosphere. In one embodiment, the conduit passes through the cathode compartment, and/or the interface between the anode compartment and the cathode compartment. The conduit may be, for example, a tube. In some cases, gas flow in the conduit may be controlled, for example, using any technique known to those of ordinary skill in the art, for example, by the use of blowers, fans, or the like.

As an example, referring now to FIG. 4, in some cases, proton exchange interface 40 separating anode compartment 20 from cathode compartment 30 may include a gas purging system. In this example, a collector 45 adjacent to anode compartment 30 and contained within proton exchange interface 40 is able to collect gases produced in anode compartment 30, and pass the gases through proton exchange interface 40 to be expelled from fuel cell 10 via conduit 47. Collector 45 may have any suitable shape for collecting a glass, for example, an “inverted funnel” shape such as is shown in FIG. 4. Those of ordinary skill in the art will be able to use suitable pumps, valves, sensors, conduits, and the like to control the flow of gas through conduit 47. For instance, in one embodiment, a very low cracking pressure check valve may be used on conduit 47 that allows gases to escape anode compartment 30 while reducing the introduction or backflow of atmospheric gases from the environment into conduit 47.

Still another aspect of the disclosure is directed to electrodes useful in fuel cells, for example, fuel cells that can use microorganisms to oxidize fuel. The electrodes may be designed to have relatively large surface areas, for example, the electrodes may be porous or comprise wires or a mesh, or a plurality of wires or meshes. In certain embodiments, multiple layers of such materials may be used. In some cases, the electrode may also be gas permeable, e.g., to avoid trapping gases such as H₂ or CO₂. In some embodiments, an electrode may include a terminal electron acceptor, and electrons collected by the electrode when a fuel is oxidized by microorganisms in the fuel cell may be collected as electricity. In some cases, the electrode may contain a conductive species, such as graphite, which may facilitate electron collection.

In one set of embodiments, the electrode is flexible and/or does not have a predefined shape. For example, an electrode may include cloth or a fabric, which may be conductive in some cases. Such electrodes may be useful, for instance, in embodiments where a currently existing system, such as a septic tank or a sewage treatment plant, is converted for use as a fuel cell. Such electrodes may also be useful, in certain cases, to increase the effective reactive surface area without increasing the weight or cost. Further, in some cases, such electrodes may be useful in increasing the amount of electrode surface area available for reaction within a compartment of a fuel cell. Examples of flexible materials suitable for use in flexible electrodes includes, but are not limited to, graphite cloth, carbon fiber cloth, carbon fiber impregnated cloth, graphite paper, etc.

In another set of embodiments, the electrode may include a non-conductive material, and a conductive coating at least partially surrounding the non-conductive material. For instance, the conductive coating may be graphite, such as a graphite-containing paint or a graphite-containing spray, which may be painted or sprayed on, respectively. The non-conductive material may be a ceramic, or a non-conducting polymer, such as polyvinyl chloride or glass. In one embodiment, the non-conductive material is the housing of the compartment itself that contains the electrode. Thus, for example, an electrode of the device may be painted on, sprayed on, or otherwise applied to a wall of the compartment. In other embodiments, however, the electrode may include a conductive material, optionally surrounded by a conductive coating. For instance, the electrode may include a metal, such as aluminum or lead.

Thus, for example, the electrodes may be formed using conductive coatings or paints. For instance, a suspension of about 10% to about 60% graphite, or about 20% to about 60% graphite in a volatile solvent (e.g., methyl ethyl ketone) with an adhesive (e.g., a fluoroelastomer) may used as a graphite paint, and use to paint a non-conductive material such as a metal, a non-conductive polymer, or a ceramic. Graphite paints are readily available commercially, and in some cases, the paint may be supplemented with additional graphite to increase its density. In some cases, a wire may be added to the surface prior to coating, and connected to an electrical load, such as those described herein. In some cases, the wire can be potted with a high-temperature water resistant adhesive, e.g. marine epoxy, that may allow the point of continuity between the wire and the conductive electrode to remain dry, even if the assembly is immersed.

In still another set of embodiments, the electrodes comprise porous materials. Such electrodes may have higher surface areas for electron transport, and/or such electrodes may provide suitable channels for mass and energy flow through the electrodes, e.g., to avoid trapping gases such as H₂ or CO₂. The average porosity of the materials may be for instance, between about 100 micrometers and about 10 mm, less than about 10 mm, less than about 1 mm, etc. The average pore size may be determined, for example, from density measurements, from optical and/or electron microscopy images, or from porosimetry, e.g., by the intrusion of a non-wetting liquid (often mercury) at high pressure into the material, and is usually taken as the number average size of the pores present in the material. Such techniques for determining porosity of a sample are known to those of ordinary skill in the art. For example, porosimetry measurements can be used to determine the average pore size based on the pressure needed to force liquid into the pores of the sample. A non-limiting example of a porous material is a laminate sheet of an inert material (for example, carbon fiber, woven titanium), e.g., formed as a mesh, or a plurality of meshes. For instance, the spacing of one, or more than one of the meshes may be between about 100 micrometers and about 10 mm, less than about 10 mm, less than about 1 mm, etc.

In some embodiments, the electrode comprises graphite. Non-limiting examples of such electrodes include graphite cloth, carbon fiber cloth, graphite paper, a graphite-containing coating, a graphite-containing paint, or a graphite-containing powder. Graphite may be useful, for example, as a conductive non-metallic material; in some cases, metal electrodes may cause the release of metal ions, which may be toxic to the microorganisms at relatively high concentrations. The electrode may be formed from graphite (e.g., a graphite plate or a graphite rod), or formed from other materials to which graphite is added and/or upon which the graphite is adhered.

Combinations of these and/or other features are also contemplated. For example, an electrode of the present disclosure may be porous and flexible, or flexible and coated with graphite.

In one aspect of the disclosure, an electrode such as those described above may be pre-treated prior to being put in the fuel cell. Such pre-treatment may be used, for example, to promote the growth of microorganisms within the fuel cell, and/or to promote the growth of pili or other cellular processes. In one set of embodiments, an anode, such as those described above, may be exposed to an acid (optionally degassed and/or heated) such as phosphoric acid or sulfuric acid (e.g., at about 0.01 M to about 0.1 M), then rinsed (e.g., with distilled water, which may be degassed in some cases). The acid treatment may occur at elevated temperatures, for example, at about 37° C., and/or for relatively long times, such as at least about 8 h. In some cases, the anode may be exposed to an organic carbon supplement (e.g., a dry bath of pulverized yeast extract or other organic supplement) and/or a nitrate (e.g., ammonium nitrate or sodium nitrate). Yeast extract is available commercially. For instance, a yeast to ammonium nitrate ratio that an electrode is exposed to may be 10:1, in one embodiment of the disclosure.

The anode may also be exposed to biomass, for example biomass that is to be used within the fuel cell, such as compost, or the like. In some cases, the biomass may be at least partially oxidized. Such treatments may stimulate the growth of microorganisms on the electrode. Without wishing to be bound by any theory, it is believed that these approaches facilitated the rapid growth of energy generating biofilms of microorganisms on the anode by reducing the oxidation at the electrode surface, and/or providing readily available substrates for growth of microorganisms as well as an inoculum from the fuel; these treatments appear to stimulate the microorganisms to produce electron shuttles (or biological mediators) that enable them better transport electrons, and/or promote the growth of pili or other cellular processes in certain microorganisms.

In another set of embodiments, the cathode may be exposed to a nitrate (e.g., sodium nitrate at 0.5 mM), and/or a noble metal (e.g., platinum, such as platinum dust or vapor-deposited platinum), which may coat the surface of the electrode. Such treatment may facilitate conversion O₂ to H₂O on the cathode and/or improve the voltage potential or net power production of the device.

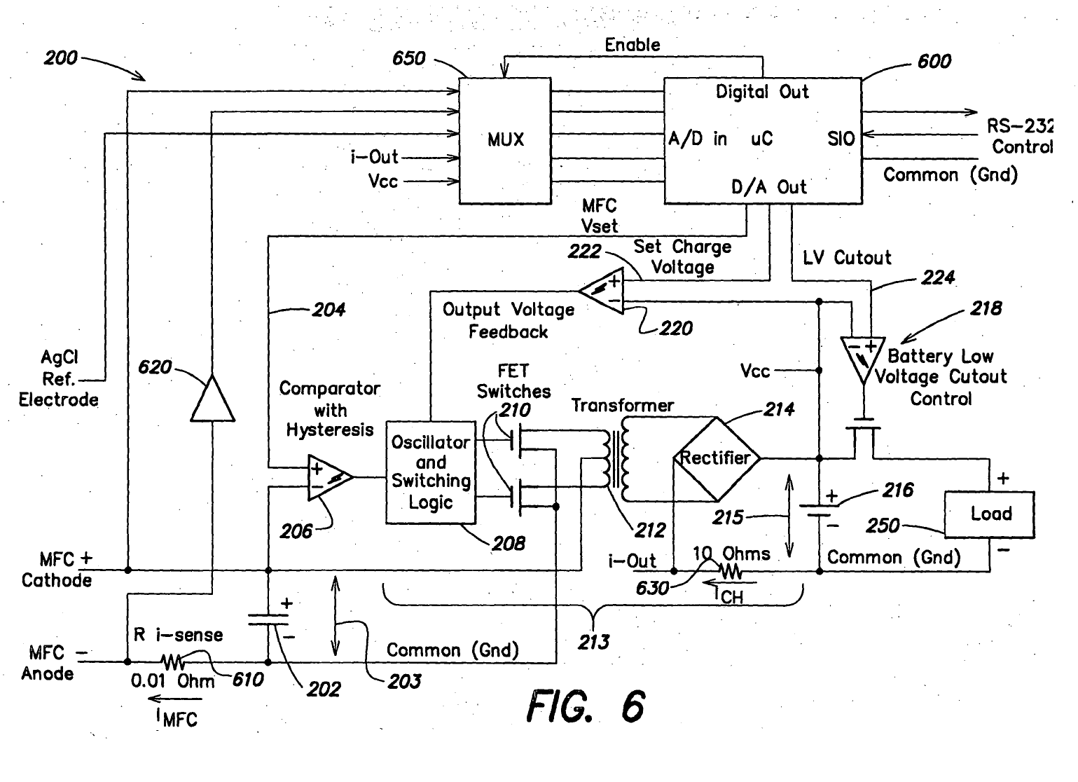

Yet other inventive embodiments according to the present disclosure, discussed in greater detail below in connection with FIGS. 5-11, relate generally to energy management methods and apparatus that may be employed in connection with one or more microbial fuel cells (MFCs), including the various examples of MFCs discussed above. In some exemplary embodiments, energy management methods and apparatus may involve voltage conversion to convert a first relatively low output voltage of one or more MFCs to a second higher voltage that is generally more suitable for providing output power to a variety of loads (e.g., lighting, fans, home appliances, electronics devices such as cell phones, radios, computers, sensors, actuators, alarms, etc.).

In some implementations, an exemplary MFC voltage may be in a range of from approximately 0.1 Volts to 0.8 Volts at a current of from approximately 50 mA to 1000 mA (i.e., an MFC power output in a range of approximately 5 mW to 1 W). The relatively low voltages typically provided by an MFC are generally difficult to convert to higher more useful voltages, due in part to the fact that many conventional solid state devices typically do not function at voltages less than 0.7 Volts. In spite of this challenge, in one aspect energy management methods and apparatus according to various inventive embodiments discussed in further detail below are particularly configured for operation based on the relatively low voltages expected from an MFC, and may provide virtually any output voltage for a load, with a corresponding maximum load current determined by the power available from the MFC(s) and the efficiency of the energy management methods and apparatus (which accounts for any attendant power consumption/loss in the transfer of energy from the MFC(s) to the load, including power consumption by any required circuitry).

In some exemplary implementations discussed below, energy management methods and apparatus are particularly configured for operation based on MFC voltages of approximately 0.3 Volts to 0.4 Volts and MFC currents of approximately 100 mA to 200 mA, to provide load voltages of approximately 3 Volts to 4 Volts and load currents of approximately 10 mA to 20 mA. It should be appreciated, however, that the foregoing exemplary parameters are provided primarily for purposes of illustration, and that the disclosure in connection with energy management methods and apparatus is not limited to the ranges of operation indicated above.

In another aspect of energy management methods and apparatus according to the present disclosure, Applicants have recognized and appreciated that a continuous draw of power from one or more MFCs results in net power production that can be stimulated by agitation, sharp increases in readily digestible carbon, etc. Applicants have also recognized and appreciated, however, that net power production can be increased by allowing a given MFC to periodically “rest” between periods of providing power to a load. In view of the foregoing, energy management apparatus and methods according to some inventive embodiments of the present disclosure involve an intermittent (e.g., periodic) coupling of one or more MFCs to any significant load (e.g., an actual load as well as any voltage conversion circuitry required to provide an appropriate load voltage), so as to provide for alternating periods of power draw from the MFC and MFC resting or “recovery.”

FIG. 5 illustrates a block diagram of an energy management apparatus 200 according to one inventive embodiment of the present disclosure for facilitating the provision of power to a load 250 from one or more microbial fuel cells (MFCs), including the various examples of MFCs discussed above. Generally speaking, the energy management apparatus 200 is based in part on concepts relating to switching power supplies (commonly referred to in the relevant literature as “choppers” or “switching converters”); more specifically, various implementations of the energy management apparatus 200 are based on boost converter concepts employing one or more switching devices (e.g., field effect transistors, or FETs), a step-up transformer, and rectification of the transformer output. In various implementations, the energy management apparatus 200 may be particularly designed to itself require an operating power of less than approximately 0.15 mW, allowing for efficient energy transfer to a load for a wide variety of MFCs.

The energy management apparatus 200 of FIG. 5 includes one or more first energy storage components 202 (illustrated generally as a capacitor in FIG. 5) to store first energy provided by one or more MFCs when an MFC voltage 203 is coupled to the storage component(s) 202. For purposes of the present discussion, the MFC voltage 203 is the difference between an anode potential and a cathode potential of one or more MFCs coupled to the first energy storage component(s) 202, wherein the anode potential serves as the “ground” potential or circuit common for at least a portion of the apparatus 200. The apparatus 200 also includes one or more second energy storage components 216 to provide output power to a load 250, as well as power required by various circuitry of the apparatus itself. Between the first and second energy storage components, the energy management apparatus 200 includes a voltage conversion circuit 213 to convert the MFC voltage 203 to a second higher voltage 215 which provides energy to (i.e., “charges”) the second energy storage component(s) 216.

In one aspect, the first energy storage component(s) 202 are selected to allow relatively quick storage of energy provided by the MFC(s), which energy in turn can be provided to the voltage conversion circuit during periods in which the MFC(s) may itself be providing less energy. In this manner, the energy storage provided by the first energy storage component(s) 202 allows the energy management apparatus to accommodate large short-period load current surges while at the same time maintaining a fairly constant MFC voltage 203, thereby preventing loss of power or ‘brown-outs’ during periods of high load power demand. In another aspect, the energy storage provided by the first energy storage component(s) 202 may also help to maintain an optimum MFC voltage 203 to facilitate efficient microbial performance.

In another aspect, the first energy storage component(s) 202 should generally have a low impedance (e.g., on the order of about 0.03 Ohms or less) so as to reduce power losses and facilitate relatively high efficiency of the apparatus 200. In one exemplary implementation, a 10,000 μF aluminum electrolytic capacitor available from Nichicon Corporation (part no. UHE1A103MHD) having an impedance on the order of 0.015 Ohms may be employed for the first energy storage component 202. In other implementations, one or more supercapacitors may be employed for the first energy storage component(s) to facilitate higher energy storage. A supercapacitor is an electrochemical capacitor that has an unusually high energy density when compared to conventional capacitors. Supercapacitors generally have very high rates of charge and discharge, little degradation over hundreds of thousands of cycles, and high cycle efficiency (95% or more). By way of example, a 60 F supercapacitor employed as the first energy storage component 202 provides approximately 15 Joules of energy storage when charged to 0.7 Volts by the MFC voltage 203.

In yet another aspect of the embodiment shown in FIG. 5, the voltage conversion circuit 213 does not operate continuously, but instead is activated intermittently (e.g., periodically) such that significant power is not being drawn from the first energy storage component(s) 202 (and in turn one or more MFCs to which it is coupled) in a continuous fashion. As discussed above, by not drawing power continuously from one or more MFCs but instead allowing for intermittent periods of power draw followed by rest/recovery, net power production by the MFC(s) is significantly increased. To this end, the apparatus 200 further includes a comparator circuit 206 that monitors the MFC voltage 203 and in turn activates and deactivates the voltage conversion circuit 213 based on different MFC voltages.

More specifically, the comparator circuit 206 shown in FIG. 5 compares the MFC voltage 203 (the voltage across the first energy storage component(s) 202) to a first set point 204. In one aspect, the comparator circuit is configured to implement a hysteresis window defined by a first predetermined level above the first set point 204 and a second predetermined level below the first set point 204. In particular, based on the hysteresis window, an output 207 of the comparator circuit changes from a first logic state to a second logic state when the MFC voltage 203 is at or above the first predetermined level, and the output 207 of the comparator circuit changes from the second logic state to the first logic state when the MFC voltage is at or below the second predetermined level. The voltage conversion circuit 213 is in turn activated in response to the second logic state and deactivated in response to the first logic state.

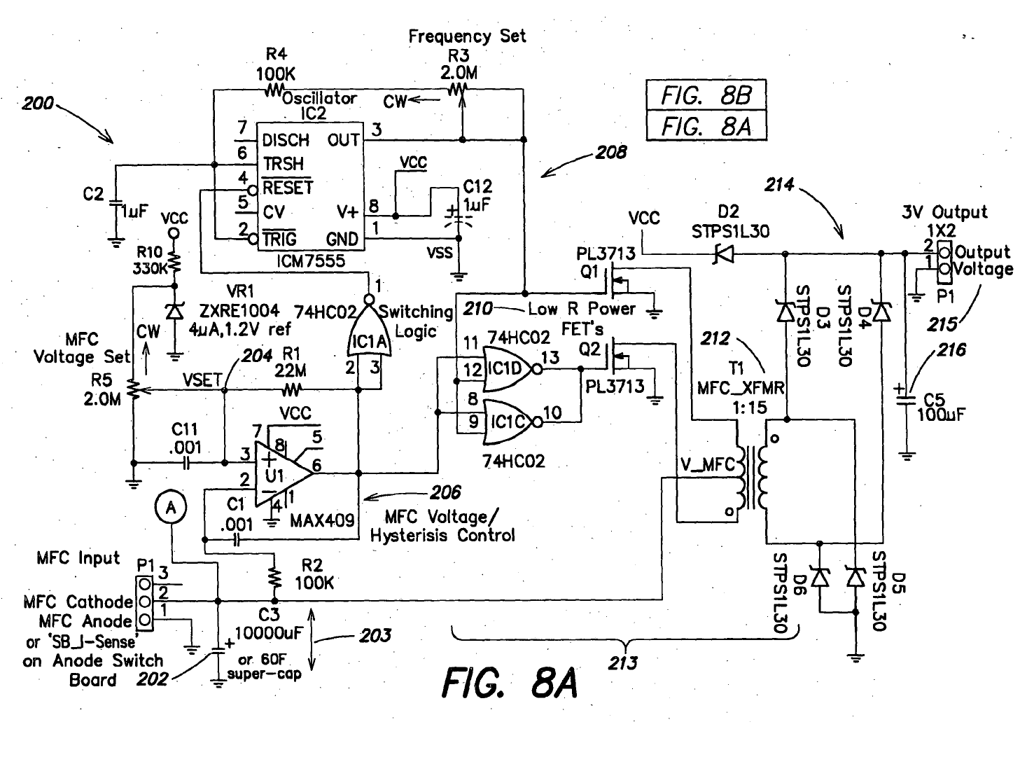

In the block diagram shown in FIG. 5, the MFC voltage 203 is provided to an inverting input of the comparator circuit 206 and the first set point 204 is applied to a non-inverting input of the comparator circuit (e.g., via a potentiometer coupled to a reference potential Vref). In one exemplary implementation (illustrated in the detailed schematic shown in FIG. 7, discussed further below), the first set point 204 is 0.35 Volts, and the comparator circuit is configured to implement a hysteresis window of approximately 3% above and below die first set point, such that the first predetermined level above the first set point is approximately 0.36 Volts and the second predetermined level below the first set point is approximately 0.34 Volts. Accordingly, when the MFC voltage rises to or above 0.36 Volts, the comparator circuit provides an output signal to activate the voltage conversion circuit 213. If the MFC voltage then falls to 0.34 Volts (or below), the comparator circuit changes the state of the output signal so as to deactivate the voltage conversion circuit. The comparator circuit does not change the output signal state so as to re-activate the voltage conversion circuit until the MFC voltage rises back to (or above) 0.36 Volts.

In the foregoing discussion, it should be appreciated that the exemplary first set point of 0.35 Volts and hysteresis window of approximately 3% are provided primarily for purposes of illustration, and that comparator circuits according to the present disclosure are not limited in these respects, as different set points and different degrees of hysteresis may be appropriate in a given application (e.g., depending on the number and type of MFCs employed). For example, in one implementation, employing a wider hysteresis window would allow one or more MFC(s) to spend more “resting” time at a higher voltage and (lower current draw) before activating the voltage conversion circuit, which as discussed above may in some cases improve net power production.

During the period in which the voltage conversion circuit is deactivated, there is no significant load on the MFC(s)/first energy storage component(s) 202 (there is no significant power drawn), and the MFC(s) is/are free to recharge the first energy storage component(s) 202. In some implementations, activation duty cycles as low as approximately 10% are feasible. In this manner, the intermittent operation of the voltage conversion circuit also provides for a generally higher efficiency for the apparatus 200 as compared to continuous operation of the voltage conversion circuit. By way of example, as discussed further below, the voltage conversion circuit may require 300 μA to 400 μA of operating current when activated, as opposed to only 40 μA of current when deactivated (quiescent state). At a circuit operating voltage of about 3 Volts, the voltage conversion circuit thereby may consume about 1 mW of power when activated, and only about 0.1 mW of power in the deactivated/quiescent state. Accordingly, for one or more low power MFC(s) (e.g., capable of providing power on the order of from about 5 mW to 100 mW), the intermittent operation of the voltage converter circuit provides for a significant increase in efficiency. Of course, it should be appreciated that for MFCs capable of higher power production (e.g., greater than 500 mW), power consumption by the voltage converter circuit may be less of an issue.

With respect to further details of the voltage converter circuit 213, as shown in FIG. 5 the circuit 213 includes oscillator and switching logic 208, FET switches 210, a step-up transformer 212, and a rectifier 214. The oscillator and switching logic 208 receives the output 207 of the comparator 206 and in turn controls the operation of two FET switches 210 that function to couple the MFC anode potential to the step-up transformer 212. As shown in FIG. 5, the MFC cathode potential is coupled directly to a center tap of a primary winding of the transformer 212, whereas the MFC anode potential is coupled to respective end taps of the primary winding via operation of the two FET switches 210. The oscillator and switching logic 208 controls the FETs so as to conduct 180 degrees out of phase with each other, thereby alternately coupling the MFC anode potential to one or the other end of the primary winding so as to provide an AC signal on the primary winding. In one exemplary implementation, a logic low signal on the output 207 of the comparator circuit 206 causes the oscillator and switching logic 208 to alternately drive the FETs and hence activate the switching operations of the energy management apparatus; conversely, a logic high signal on the output 207 of the comparator circuit 206 causes the oscillator and switching logic 208 to deactivate the switching operations of the FETs 210 and maintain both FETs in an off (non-conducting) state.

As discussed above, it is desirable for the energy management apparatus 200 to operate effectively and efficiently at MFC voltages as low as 0.1 Volts (or in some cases less), up to 0.8 Volts. Such generally low voltages require very low impedance switching devices (FETs 210) and low resistance in the primary winding of the transformer 212 to avoid heating (I²R) losses in the current path and resulting reduced efficiency due to “wasted” power. In one exemplary implementation, the FETs are particularly selected and the transformer is custom designed such that a combined primary winding and FET switching resistance is less than approximately 0.01 Ohms, resulting in efficiencies greater than 80% at MFC voltages of 0.35 Volts and MFC currents from approximately 0.1 to 1.0 Ampere. In one exemplary implementation, the frequency at which the oscillator and switching logic 208 activates the FETs 210 is selected to be below approximately 1 kHz so as to significantly reduce capacitive switching losses associated with the FETs.

With respect to the design of the step-up transformer 212, a turns ratio for the secondary winding and primary winding of the transformer corresponds approximately to the desired output voltage of the transformer divided by the minimum useful MFC voltage. In one embodiment, as shown in FIG. 5, the transformer secondary winding is coupled to a rectifier 214 which provides as an output a rectified voltage 215 based on the boosted AC signal on the secondary winding. The second energy storage component(s) 216 is/are coupled to the rectifier 214 to receive charging energy via the rectified voltage 215 and in turn provide output power to the load 250, as well as various circuitry of the apparatus 200.

In one exemplary implementation, a lithium-ion cell serving as the second energy storage component 216 may provide a nominal voltage of approximately 15 Volts to the load 250 and require a charging voltage (the rectified voltage 215) of approximately 4.2 Volts. Taking for example a minimum MFC voltage of approximately 0.3 Volts, the transformer input/output voltage ratio to accommodate proper charging of the lithium-ion cell is 0.3/4.2, or 1/14. Considering also that there is a small voltage drop due to the diodes of the rectifier 214 (which would require a secondary winding voltage somewhat higher than the charging voltage of 4.2 Volts for the lithium-ion cell), the transformer turns ratio (primary/secondary) in this example should be somewhat higher than 1/14 (e.g., 1/15 or 1/16).

In another aspect, the transformer 212 shown in FIG. 5 may utilize a high permeability SiFe core material, which allows for lower frequency operation than that allowed by a ferrite core material. The size of the transformer core, as well as the wire size for the windings, may vary depending on the expected power from the MFC, and to some extent on the desired output voltage. In one exemplary implementation, low frequency operation (e.g., less than 1 kHz) and low transformer core loss allow the voltage conversion circuit 213 to operate with a current draw during activation of less than 0.1 mA (e.g., 300 to 400 μA).

With respect to the second energy storage component(s) 216, chemical charge storage devices (batteries) such as a lithium-ion cell typically have a minimum charge current below which charging becomes inefficient or even ceases. Accordingly, allowing a sufficient charge current to come in bursts from the rectifier 214 significantly increases the efficiency of getting energy provided by one or more MFCs into a battery. This is yet another advantage of controlling the energy management apparatus's switching operations intermittently based on a range of MFC voltages as opposed to continuous operation. Additionally, the second energy storage component(s) 216 act(s) as a filter to smooth out the current bursts from the rectifier 214.

While a specific example of a lithium-ion cell is discussed above as a possible second energy storage component 216 from which output power to the load 250 is provided, it should be appreciated that other implementations of an energy management apparatus according to the concepts discussed herein may employ other types of output energy storage devices. For example, the second energy storage component(s) 216 may include battery types other than a lithium-ion cell for long period storage, or alternatively one or more conventional capacitors or supercapacitors for more robust short-term storage.

In yet another aspect of the embodiment illustrated in the block diagram of FIG. 5, the energy management apparatus 200 may optionally include an output voltage feedback circuit 220 to also control the activation and deactivation (e.g., switching operations) of the voltage converter circuit 213. For example, when the second voltage 215 output by the rectifier 214 is at a predetermined value represented by the “set charge voltage” set-point 222 (e.g., when a battery is charged or when a capacitor reaches a preset maximum voltage), the output voltage feedback circuit 220 provides a signal (e.g., to the oscillator and switching logic 208) to deactivate switching operations in connection with the FETs 210. Accordingly, in one aspect, the output voltage feedback circuit 220 prevents over-charging a battery or capacitor serving as the second energy storage component 216. In another aspect, the action of the output voltage feedback circuit 220 “trumps” the action of the comparator circuit 206 by deactivating the voltage converter circuit 213 irrespective of the MFC voltage 203, thereby allowing MFC resting as long as the second energy storage components) 216 is/are adequately charged. In yet another aspect, the feedback circuit 220 may implement a hysteresis window, similar to that discussed above in connection with the comparator circuit 206, to provide a range of voltages for which activation and deactivation of the voltage converter circuit may occur. Further details of a voltage feedback circuit 220 with a hysteresis window are shown in the detailed schematic of FIG. 7.

In yet another aspect of the embodiment shown in FIG. 5, the second energy storage component(s) 216 may also be protected by an optional cutout control circuit 218 that disconnects the load 250 from the second energy storage component(s) 216 when the voltage 215 is below a “low voltage cutout” set-point 224, thereby preventing damage from excessive discharge (excessive discharge can be a problem especially with lithium-ion cells). Like the comparator circuit 206 and the voltage feedback circuit 220, the cutout control circuit 218 may implement a hysteresis window. In the block diagram of FIG. 5, the first set-point 204 for the comparator circuit 206, as well as the set charge voltage set-point 222 and the low voltage cutout set-point 224, may be set manually (as indicated in FIG. 5 by respective potentiometers coupled to a reference voltage).

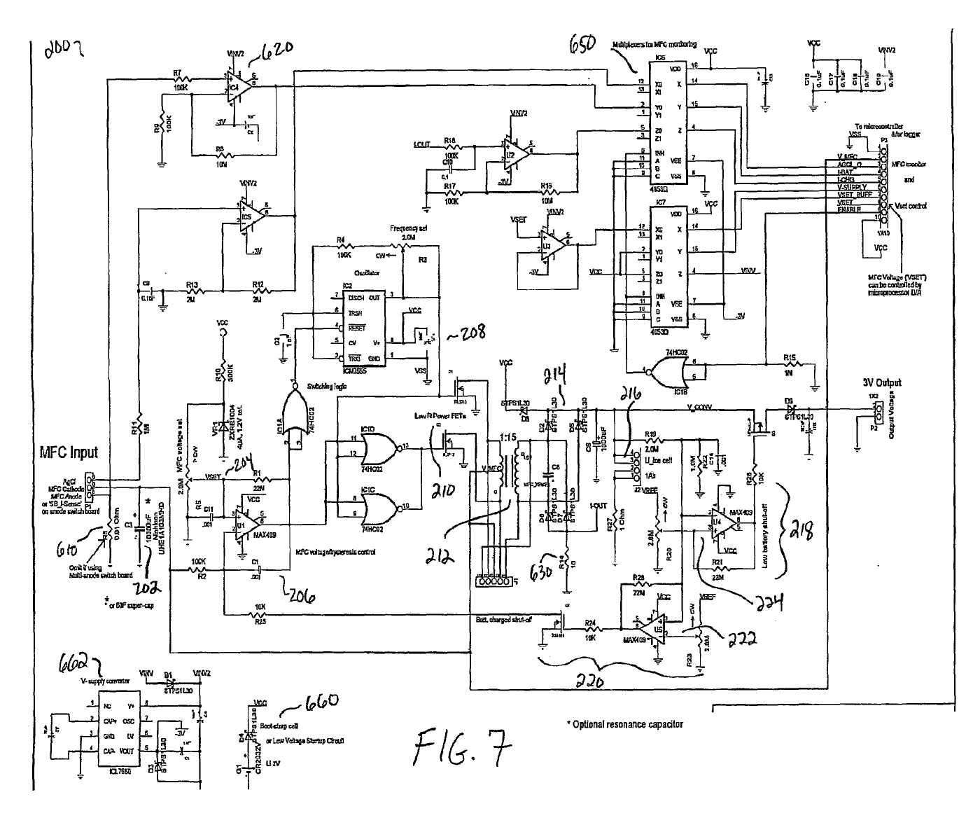

FIG. 6 is a block diagram illustrating an energy management apparatus 200 according to another inventive embodiment of the present disclosure, in which the apparatus further includes a microprocessor 600 and a multiplexer 650 to facilitate the exchange of various signals to and from the microprocessor 600. For example, in various aspects of this embodiment, the apparatus may be configured such that the microprocessor 600 monitors one or more signals/voltage levels associated with the apparatus and in turn controls one or more of the set points 204, 222 and 224 based at least in part on one or more of the monitored signals/voltage levels. Examples of signals/voltage levels that may be monitored by the microprocessor 600 include, but are not limited to, MFC cathode voltage, MFC anode voltage, the second voltage 215 across the second energy storage component(s) 216 (labeled as “VCC” in FIG. 6), a signal relating to MFC current (labeled as “I_{MFC}” in FIG. 6), a signal relating to a charging current (labeled as “I_{CH}” in FIG. 6) of the second energy storage component(s) 216, and a silver chloride (AgCl) reference electrode, discussed in greater detail below.

As illustrated in FIG. 6, to facilitate current sensing, a first current sense resistor 610, having an appreciably small resistance of 0.01 Ohms, is employed together with an amplifier 620 to facilitate sensing of the MFC current I_{MFC}. A very small resistance is selected for the sense resistor 610 so that the common (“ground”) potential for the apparatus 200 is virtually identical to the MFC anode potential (for purposes of the following discussion, the MFC voltage 203 is taken as the voltage across the first energy storage component(s) 202 when a current sense resistor is employed). A second current sense resistor 630 is coupled between the rectifier 214 and the second energy storage component(s) 216 to facilitate sensing of the charging current I_{CH}.

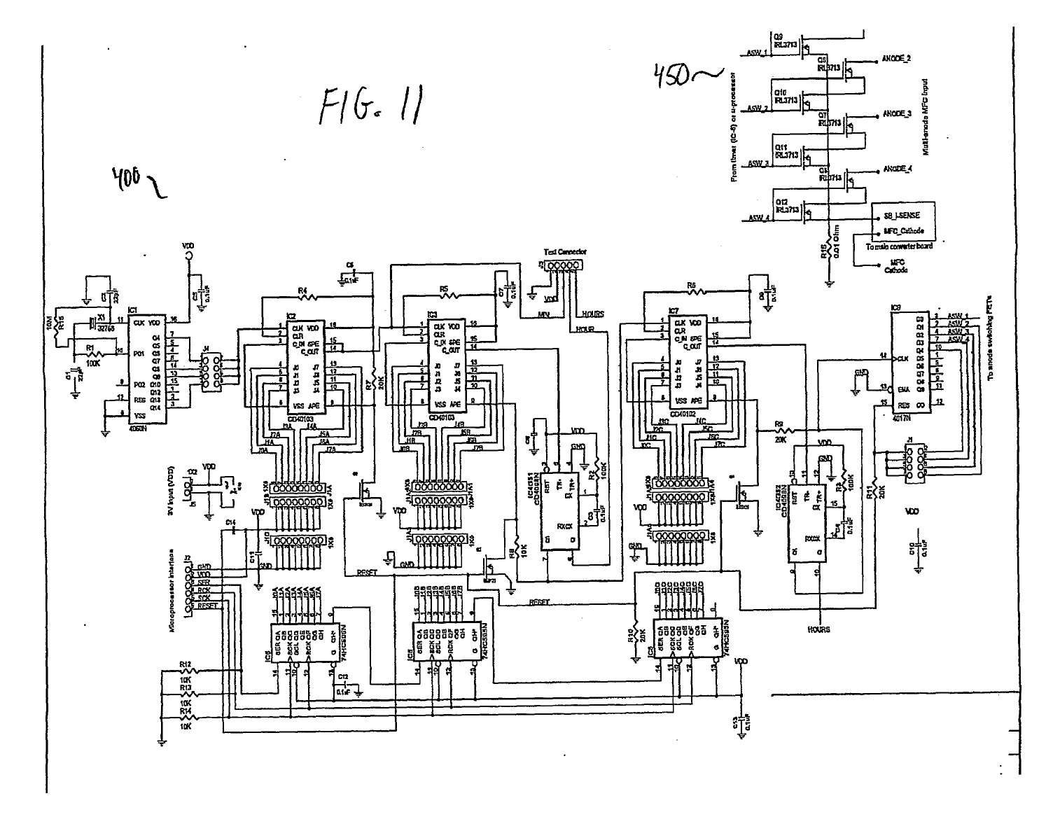

In one aspect, the microprocessor 600 of the apparatus 200 shown in FIG. 6 allows the energy management apparatus to continuously adjust circuit parameters (e.g., the comparator set point 204, the set points 222 and 224 associated with the optional voltage feedback and cutout circuits, a width of the hysteresis window for any one or more of the set points 204, 222, and 224, etc.) to increase or optimize power efficiency, and to provide an improved or optimized electrochemical environment for bacteria of the MFC(s) to facilitate power production. Under microprocessor control, the voltage converter circuit 213 can be turned off and on virtually at any time during the charge/discharge cycle of the second energy storage component(s) 216 to facilitate MFC resting/recovery. As discussed further below in connection with FIG. 11, in one exemplary implementation the microprocessor 600 can also be employed to control a coupling circuit for use with multiple MFCs to sequentially couple the MFCs to the first energy storage component(s), so as to allow for continuous cycling of rest periods and balancing of loads on multiple MFCs.

As mentioned above, the microprocessor 600 of FIG. 6 may monitor the respective anode and cathode potentials of the MFC(s) with respect to a silver chloride (AgCl) reference electrode, to in turn set the voltage of one or both of the anode or the cathode independently with respect to the reference AgCl electrode. AgCl electrodes are commonly used in electrochemistry as a reference potential (i.e., one that is precisely known and does not change much). Measuring another electrode against an AgCl electrode essentially defines the measured electrode's electrochemical potential. Since the energy management apparatus 200 essentially controls the potential difference between two undefined electrodes (i.e., the MFC cathode and anode), in some implementations it may be useful to know what the absolute potential is of each of the MFC anode and cathode, so as to evaluate any weakness in the MFC. For example, if it is determined in a given implementation that one of the MFC anode and cathode potential has a significant effect on MFC power generation efficiency, then the absolute potential of either the MFC anode of the cathode with respect to the AgCl reference electrode may be controlled via the microprocessor 600.

FIG. 7 illustrates a detailed schematic of an energy management apparatus 200 according to yet another embodiment that is configured for use with a microprocessor/microcontroller, similar to that discussed above in connection with FIG. 6. In the schematic of FIG. 7, a microprocessor itself is not shown; rather, a connector P3 is shown in the upper right hand corner, which may provide a connection to a microprocessor (e.g., the microprocessor 600 of FIG. 6) to convey various signals/voltage levels to and from the microprocessor, as discussed in greater detail below. Also, in the embodiment represented by the schematic of FIG. 7, control of the set points 222 and 224 associated with the voltage feedback circuit 220 and the cutout circuit 218; respectively, is manual (i.e., not under microprocessor control), whereas control of the set point 204 associated with the comparator circuit 206 may be either manual or under microprocessor control. It should be appreciated, however, that as discussed above, any one or more of the set points 204, 222 and 224 may be controlled by a microprocessor/microcontroller.

On the left side of FIG. 7A, a connector P1 (labeled as “MFC Input”) is shown to facilitate connection to respective cathode and anode electrodes of an MFC, as well as an optional AgCl reference electrode. Operational amplifier IC5 serves as a buffer amplifier for the AgCl electrode, and operational amplifier IC4 serves as an MFC anode current sensing amplifier 620. The outputs of IC4 and IC5 are coupled to one of two multiplexers 650 (IC6), which is enabled via an ENABLE signal from the microprocessor on pin 9 of the connector P3. Via the multiplexer IC6, the outputs of IC4 and IC5 are passed to the microprocessor for monitoring as the signals I-BAT (MFC anode current monitor) and AGCL (reference electrode monitor), respectively.

In FIG. 7, operational amplifier U1 forms a part of the circuit that implements the comparator 206 with hysteresis, as discussed above in connection with FIG. 5. The MFC voltage set-point 204 shown in FIG. 5 is indicated in FIG. 7 as VSET, and is also provided to buffer amplifier U3, which is coupled to the multiplexer IC7 to pass the signal VSET BUFF to the microprocessor for monitoring. As indicated just below the connector P3 in FIG. 7B, via a D/A converter the microprocessor also may provide the voltage VSET directly to the operational amplifier U1, rather than have VSET determined manually via the potentiometer R5.

In the schematic of FIG. 7, IC1A, IC1C, IC1D and IC2 constitute the oscillator and switching logic 208 shown in FIGS. 5 and 6, and transistors Q1 and Q2 constitute the FET switches 210 shown in FIGS. 5 and 6. The transformer T1 in FIG. 7 (element 212, as shown in FIGS. 5 and 6) is indicated as having a primary to secondary winding ratio of 1:15 (wherein the primary is considered to be the winding on either side of the center tap). The output voltage feedback circuitry 220 is implemented by the operational amplifier U5, and the low voltage cutout control circuitry 218 is implemented by operational amplifier U4 and transistor Q3. Charging current provided by the output of the rectifier 214 (diodes D2, D5, D6 and D7) may be monitored by the microprocessor via the amplifier U2 (input signal I-OUT) and the multiplexer 106 as the signal I-CHG (pin 5 of connector P3).

In FIG. 7, all of the energy management apparatus logic is supplied by a voltage VCC obtained from the output of the rectifier 214. As shown at the bottom left of FIG. 7, a small boot strap lithium battery also may be employed as a “bootstrap cell” 660 to provide operating power to the energy management apparatus logic if the second energy storage component(s) 216 are significantly or completely depleted (e.g., in an extreme case of a lithium-ion cell serving as the second energy storage component 216 going completely dead). As also shown in the bottom left of FIG. 7, a voltage supply converter 662 provides a negative operating voltage (e.g., −3.0 V) for the monitoring/sense amplifiers IC4, IC5, U2 and U3. An input voltage VINV to the voltage supply converter 662 is derived from VCC, but disconnected from the converter 662 via the multiplexer IC7 when the multiplexers IC6 and IC7 are disabled via the microprocessor ENABLE signal on connector P3.

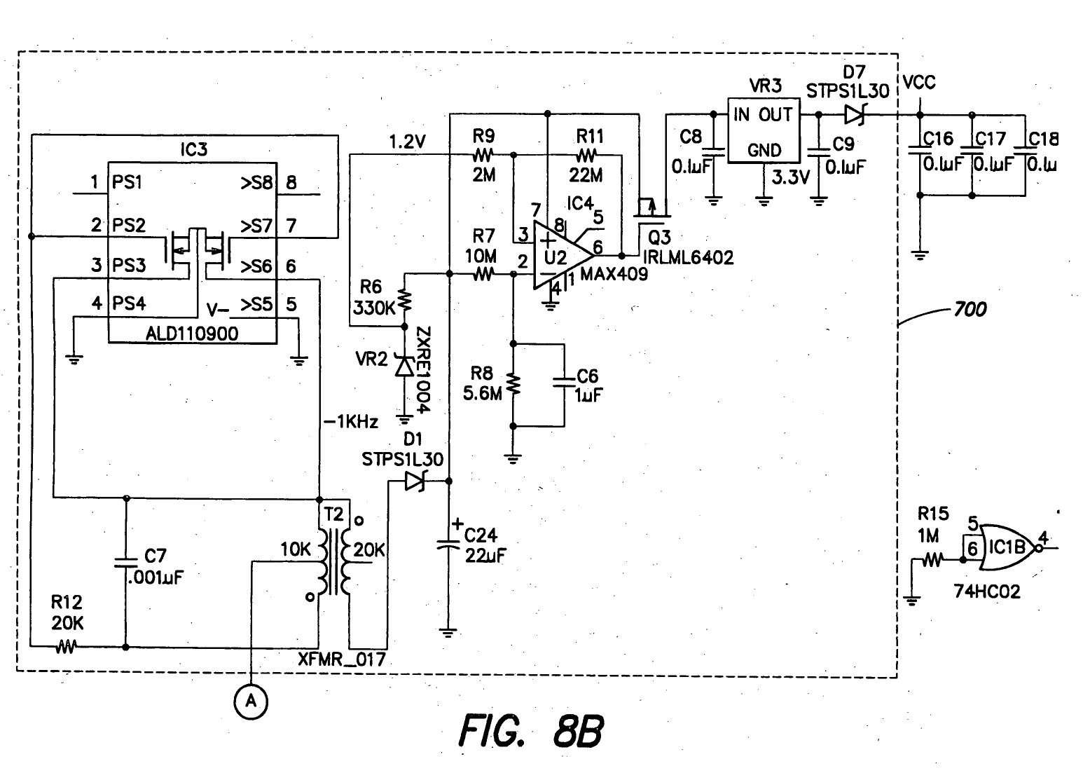

FIG. 8 illustrates yet another inventive embodiment of an energy management apparatus 200 according to the present disclosure. The embodiment of FIG. 8 includes a power supply circuit 700, coupled to the first energy storage component(s) 202, to provide operating power for at least the comparator circuit 206 and the voltage conversion circuit 213 based only upon the MFC voltage 203. More specifically, the power supply circuit 700 provides for “self-starting” of the apparatus 200 when the output voltage 215 (VCC) provided by the rectifier 214 is insufficient to provide the operating power for at least the comparator circuit and the voltage conversion circuit (e.g., the voltage conversion circuit is deactivated and the second energy storage component(s) 216 is/are significantly or completely discharged/depleted). In the schematic of FIG. 8, no voltage output feedback circuit or low output voltage cutout circuit is employed, the set point 204 for the comparator 206 is set manually, and the second energy storage component(s) 216 is given by a conventional capacitor C5. However, it should be appreciated that the power supply circuit 700 illustrated in FIG. 8 may be employed together with features discussed above in connection with other embodiments of an energy management apparatus (e.g., optional voltage feedback and cutout circuitry, microprocessor monitoring/control, one or more rechargeable batteries or supercapacitors as second energy storage component(s), etc.).

The power supply circuit 700 employs a pair of zero-threshold (zero-bias) FET devices (IC3) and a transformer T2 as a free running Hartley oscillator having a frequency of approximately 1 KHz. The power supply circuit starts oscillating at an MFC voltage 203 of approximately 0.2V, and the output of the transformer T2 provides a voltage of about 3 Volts across capacitor C4 when the MFC voltage is above 0.3V. The power supply circuit 700 provides an output voltage VCC via diode D7 when the voltage across the capacitor C4 rises above 3.6V. The power supply circuit draws a current of only about 60 μA from an MFC voltage of 0.4 Volts.

More specifically, in one exemplary implementation the zero-threshold devices IC3 of the power supply circuit 700 may be a matched pair of zero-bias MOSFETs, available from Advanced Linear Devices, Inc. (part no. ALD110900). The transformer T2 is employed as: (1) a feedback element to the gate(s) of IC3; (2) a resonant circuit (an inductance L of the primary winding with capacitor C7 in parallel with a parasitic capacitance in the transformer winding(s)); and (3) as a voltage multiplier. The secondary winding of the transformer is wired as an auto-transformer (non-isolated secondary) to boost the voltage. The voltage amplification provided from both a winding ratio of about 1:6 (6×) and the LC resonance combines to give an output voltage on the transformer secondary of approximately ten times the input voltage (this can be changed, of course, by changing the transformer turns ratio).

In the power supply circuit 700 shown in FIG. 8, the operational amplifier IC4, transistor Q3, and voltage regulator VR3 are configured to allow the DC voltage across capacitor C4 to rise above 3.5 Volts before supplying the voltage VCC as a startup voltage (via the diode D7) to the comparator circuit 206 and the voltage conversion circuit 213, which allows for a rapid startup. Resistors R9 and R11 associated with the operational amplifier IC4 provide a hysteresis window of about 10% in the startup voltage. The voltage regulator VR3 maintains the supply voltage VCC at 3.3V, and the diode D7 prevents the voltage converter circuit 213, once running, from back-feeding current into the voltage regulator VR3 (to save power).

In yet another embodiment, the power supply circuit 700 shown in FIG. 8 may be employed as an oscillator to replace IC2 (ICM7555) in the oscillator and switching logic circuit 208. However, the oscillator waveform provided by the circuits of the power supply circuit 700 is asymmetrical; to address this asymmetry, an output of the oscillator may be passed through a divider (½) to make it symmetrical for driving the transistors 210 of the voltage conversion circuit 213.

In various implementations, it should be appreciated that multiple MFCs may be employed with energy management apparatus discussed above in connection with any of FIGS. 5-8 to provide power to a load. For example, multiple MFCs may be connected in series to provide a higher voltage as an input to the energy management apparatus (as long as each MFC is independent and not connected in any way other than the conductors that connect them in series). However, it should be appreciated that such a series connection of multiple MFCs in practice may pose significant challenges with respect to efficiency. In particular, in such a series connection, the current available from the array of series-connected MFCs is a net result of the energy producing capability of respective MFCs, which in fact may not be similar. Stated differently, it is virtually impossible to balance/optimize current production amongst all of the series-connected MFCs, and as such, the efficiency per MFC in most cases significantly decreases due to the series connection. In another implementation, however, multiple MFCs may nonetheless employed to provide power to a load by sequentially coupling the MFCs to a load pursuant to a “load balancing” implementation according to one embodiment of the present disclosure.

As discussed earlier, Applicants have recognized and appreciated that net power production can be increased by allowing an MFC to rest between periods of significant power draw from the MFC. Furthermore, Applicants have recognized and appreciated that an exemplary time period during which significant power is allowed to be drawn from a given MFC before allowing the MFC to rest may be based on a comparison of instantaneous power output by an exemplary MFC over some time period during which the MFC is continuously coupled to an exemplary load (e.g., an energy management apparatus including a lithium-ion cell as the second energy storage component) and the charge state of the first energy storage component(s).

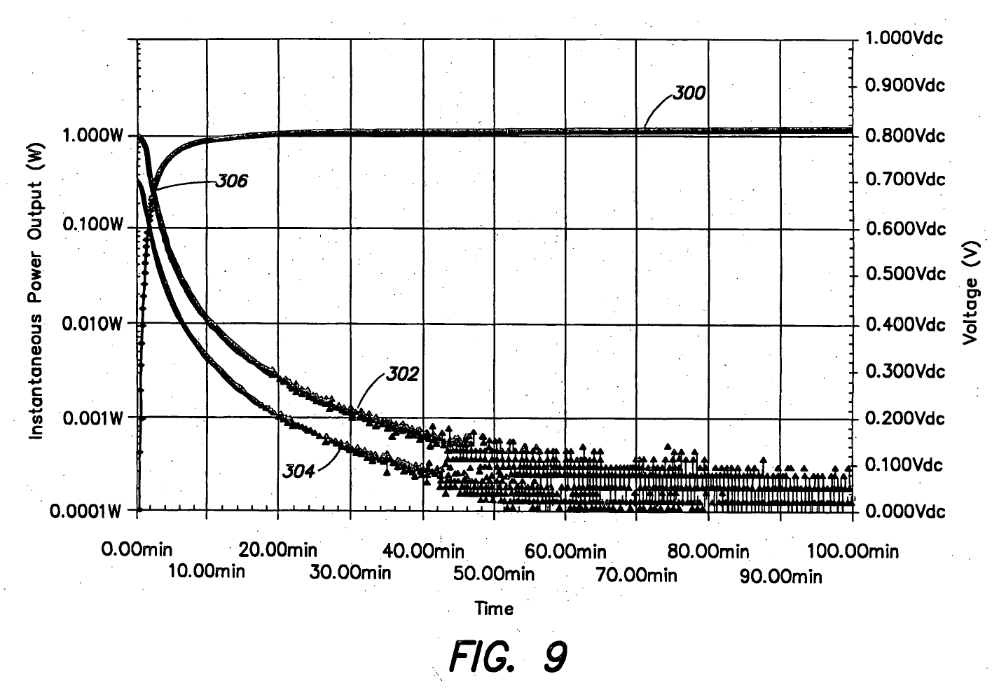

For example, in one experiment, an MFC voltage and current was measured for two different microbial fuel cells (0.5 m²) respectively operating at two different temperatures (25 degrees Celsius and 10 degrees Celsius) to calculate instantaneous power output by the MFCs. With reference to FIG. 9, the instantaneous power outputs were then plotted with respect to time, wherein the plot 302 corresponds to the MFC at 25 degrees C., and the plot 304 corresponds to the MFC at 10 degrees C.) (power is shown on the left vertical axis with a log scale and voltage is shown on the right vertical axis with a linear scale). The charge state of a 60 F supercapacitor serving as an exemplary first energy storage component 202 is also plotted in FIG. 9 as the plot 300. An exemplary time period for allowing power to be drawn from the MFC is taken as the intersection 306 of the MFC instantaneous power and supercapacitor charge state plots, which in FIG. 9 is shown to be approximately two to four minutes. By disconnecting the MFC after this intersection point, and allowing it to rest/recover for some time period thereafter, the MFC is allowed to provide it's peak power output again (approximately 1 W in FIG. 9), rather than a significantly lower steady state power production (as seen after 60 minutes in FIG. 9 as less than 0.001 W). In one aspect, the time period represented by the intersection between instantaneous continuous power drain of an MFC and a charging rate of the first energy storage component may provide a basis for selecting the first set point 204 for the comparator circuit 206.

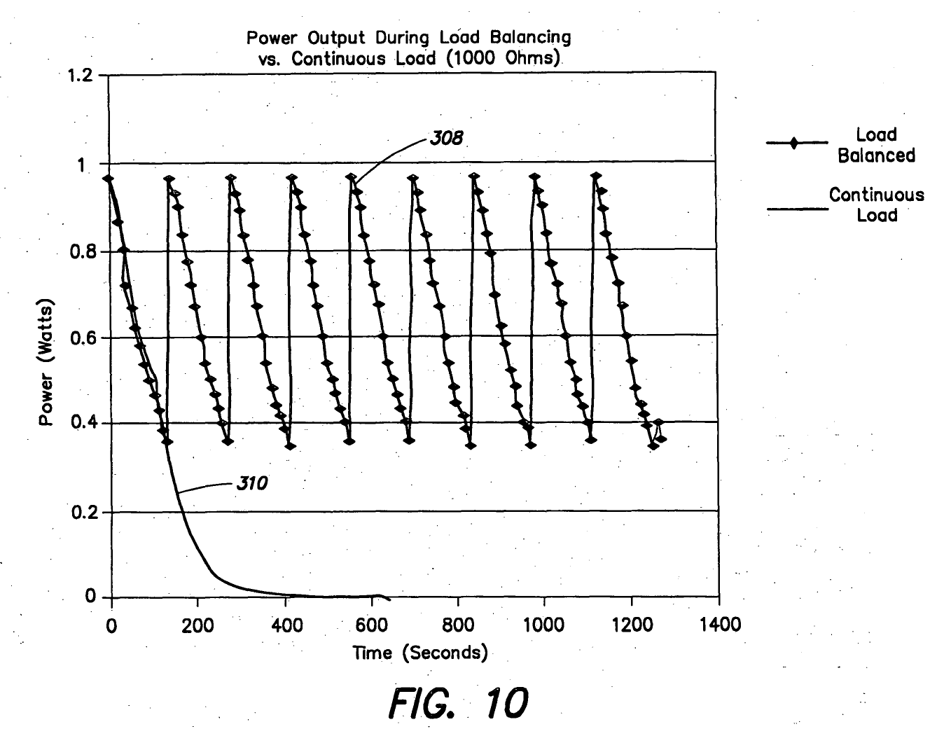

FIG. 10 shows another plot 308 of power output over time of nine exemplary MFCs that are sequentially coupled to a load, in which each MFC is coupled to the load for approximately 2 minutes and then allowed to rest for the remainder of the sequencing cycle (e.g., approximately 15 to 16 minutes). Stated differently, the nine MFCs are sequentially coupled to the load in a “round-robin” fashion. FIG. 10 also shows a plot 310 of power output over time by a single MFC, having a surface area that is slightly greater than the equivalent surface area of all nine MFCs, and continuously connected to the same load. From FIG. 10, it may be readily appreciated that when multiple MFCs are cycled as opposed to continuously connected to a load, instantaneous power output increases dramatically (e.g., in some cases by as much as 900%), resulting in significant net power output gains (e.g., in some cases of up to approximately 40 to 120%). The applicants have observed that such “round robin” cycling stimulated and sustained chemical and biological processes that yield greater transport of electrons to the anode surface. For example, this includes but is not limited to replenishment of organic carbon via diffusion into the anode-hosted biofilms (as determined via microelectrode profiling), re-establishment of acid-base balance on the anode (again, as determined via microelectrode profiling), regeneration of electron shuttles (as occurs on the cathode as determined by fluorescent and spectroscopic imaging), and potential increases in microbial metabolism (as observed by isotopic tracer studies). While an exemplary rest period of approximately 15 minutes is provided by the example given in FIG. 10, the duration of an appropriate or even optimum rest period may depend at least in part on the size of the electrodes used in the MFC, the operating temperature, organic carbon load, the microbial community diversity, density and distribution, and other aspects of the MFC and its environment.

FIG. 11 illustrates a timer circuit 400 and a coupling circuit 450 according to one embodiment of the present disclosure, to be used in conjunction with an energy management apparatus 200, for implementing the cycling or “load balancing” technique discussed above in connection with FIG. 10. For purposes of illustrating the general functionality of the timer circuit and the coupling circuit in implementing the load balancing technique, four MFCs rather than nine MFCs are considered. It should be appreciated, however, that any number of MFCs may be employed according to various implementations.

In FIG. 11, the respective anodes of four different MFCs are coupled to FETs Q5-Q8 of the coupling circuit 450 (shown in the top right of FIG. 11D), while the cathodes of the four MFCs are coupled together to the first energy storage component(s) 202 of an energy management apparatus 200 (as shown in FIGS. 5-8). The timer circuit 400 includes a plurality of very low power programmable timers to set the anode switching cycle time from approximately 1 minute to 99 hours/anode, and provides four FET enable signals ASW_1 through ASW_4 via IC9 of the timer circuit to the respective gates of FETs Q5-Q8. All of the integrated circuits constituting the tinier circuit 400 draw operating power from the voltage VCC provided by the rectifier 214 in FIGS. 5-8. In yet another embodiment, rather than employing the programmable timers shown in FIG. 11, the microprocessor 600 shown in FIG. 6 may be employed to generate the FET enable signals ASW_1 through ASW_4 so as to sequentially drive the FETs Q5-Q8 and thereby couple respective anodes in turn to the first energy storage component(s) 202 of an energy storage apparatus. In this manner, the respective time periods during which power is drawn from a given MFC and a corresponding rest period for the MFC may be under microprocessor control, and based on any number of parameters (e.g., signals/voltage levels monitored by the microprocessor).

In the circuit of FIG. 11D, the FETs Q5-Q8 of the coupling circuit 450 are N-channel devices, and so they are designed to run with their drain (the terminal connected to the anodes) always positive with respect to the source (connected to resistor R15 and ultimately to ground). The floating anodes, however, in some cases may drift more negative than the source voltage, and so the FETs may be biased ‘backwards’ (i.e., in an unconventional manner). There is an intrinsic diode between the drain and source of each FET that prevents the drain voltage from exceeding −0.6 Volts with respect to the source voltage. Applicants have recognized and appreciated that the FETs actually turn on effectively when the drain is more negative than the source, but the intrinsic drain body diode keeps the maximum usable backwards bias to less than 0.6 Volts. In view of the foregoing, in one embodiment of the coupling circuit 450 two FETs are employed in series per MFC to arrive at a total maximum backward bias of 1.2 Volts. Since the MFC anode to cathode voltages typically remain below −0.8V, the two FETs in series are sufficient to preclude inadvertent reverse bias conduction. In an alternative implementation, a single FET per MFC may be sufficient if MFC voltages of typically less than 0.6 Volts are expected (but two FETs in series may still be employed to ensure robust operation). In one aspect, the FETs Q5-Q8 are ‘zero power’ devices in that it takes no current to maintain their on or off status, and they have an ‘on’ resistance of less than 0.003 Ohms. As also shown in FIG. 11D, the resistor R15 may serve a current sense resistor, similar to the resistor 610 shown in FIGS. 6 and 7; accordingly, the resistor 610 is not required in the apparatus shown in FIGS. 6 and 7 if the coupling circuit 450 is employed with an energy storage apparatus 200 to facilitate cycling of multiple MFCs and input current sensing is desired.

The fuel cells of the present disclosure may be used in a wide variety of applications, including virtually any application where electrical power is desired. Non-limiting examples of such applications include lighting; powering electrical devices such as cell phones, radios, computers, etc.; powering water pumps; security applications (e.g., controlling sensors); or powering devices for people living off an electrical grid (e.g., in developing countries). Still other non-limiting examples include home and garden applications (e.g., moisture detection, lighting), portable toilets (e.g., lighting, fans, electronic signal transmission such as a fullness detector), home security (e.g., motion sensors, alarms, electronic signal transmission), military applications (e.g., border sensors, field power, lighting), public highways (e.g., road markers, signs, speed detectors), buoys or oceanographic applications (e.g., lighting for buoys, electronic signal transmission), camping or hiking applications (e.g., lighting), parks (e.g., lighting for pathways, walls, etc., or decorative lighting), or agricultural applications (e.g., pH sensors, moisture sensors, etc.).

The following documents are incorporated herein by reference: U.S. Provisional Patent Application Ser. No. 60/845,921, filed Aug. 20, 2006, entitled “High-performance Thermophilic Microbial Fuel Cell,” by Girguis, et al.; U.S. Provisional Patent Application Ser. No. 60/914,025, filed Apr. 25, 2007, entitled “Methods and Apparatus for Providing Power from Microbial Fuel Cells,” by Girguis, et al.; and U.S. Provisional Patent Application Ser. No. 60/914,108, filed Apr. 26, 2007, entitled “Methods and Apparatus for Stimulating and Managing Power from Microbial Fuel Cells,” by Girguis, et al. The following examples are intended to illustrate certain embodiments of the present disclosure, but do not exemplify the full scope of the disclosure.

### Example 1

This example illustrates a novel high-performance thermophilic microbial fuel cell that is designed for and capable of producing between 6 and 16 times greater power output than convention microbial fuel cells, according to one embodiment of the present disclosure.

Metabolism may be defined as the chemical processes occurring within a living cell that are necessary for the maintenance of life. In general, metabolic reactions can be broken down into two groups: reactions that break down “food” into chemical compounds for synthesizing new biological components for growth and maintenance, and reactions that generate energy to support this growth and maintenance.

Energy metabolism is based around “reduction-oxidation” chemical reactions, in which organisms harness the energy released while transferring electrons from electron-rich chemicals such as sugar to electron-deficient chemicals such as oxygen. For instance, animals typically use oxygen as the final acceptor of these electrons. As such, oxygen may be called a terminal electron acceptor. Some microbes however, are able to use other materials (e.g., solids, metals, minerals, etc.) as a terminal electron acceptor instead of oxygen. Such microbes have typically been identified in anaerobic environments, where the low concentration, or absence, of oxygen prohibits its use in metabolism. As such, these anaerobic microorganisms transfer their electrons to solid materials such as metals or minerals.

In general, organisms are only capable of retaining between 10% and 40% of the energy found in their food, regardless of its quality. Much of the remaining energy is lost to the environment as heat (in accordance with the Second Law of Thermodynamics). This is especially relevant for small organisms such as microbes that are not able to retain substantial heat within their bodies to do additional work.

Despite the inability of many organisms, including microbes, to harness heat for work, their metabolic rate is often proportional to temperature (up to an organism's thermal limit). This relationship between metabolic rate and temperature is often expressed as Q₁₀, which measures the rate increase for each 10° C. rise in temperature. For example, if the rate triples for each 10° C. rise, then the value of Q₁₀ is 3. Metabolic rates, in general, often have a Q₁₀ of around 2. If the metabolic rate of an animal at 0° is X, then at 10° C. the rate would be 2×, at 20° C., 4×, etc. Typically the rate increases more rapidly as the temperature increases. As such, if the heat is retained in the environment (e.g., by natural or artificial means), the metabolic rate of the organism may be increased, for example, up to 16-fold between 10° Celsius and 70° Celsius.

While some animals can tolerate temperatures up to 55° C., microbes are clearly the most thermophilic (or heat loving) organisms known to date. For example, some microbes prefer to live at warm to hot temperatures (about 30° C. to about 50° C., and about 50° C. to about 90° C., respectively) are referred to as mesophiles or thermophiles respectively. Some microbes have been shown to live at temperatures up to 121° C. The activity of these microbes can be observed in exotic environments such as deep sea hydrothermal vents, as well as more common environments such as compost piles or peat bogs, as well as anthropogenic environments such as sedimentation ponds, sewage digestors, anaerobic digestors, etc. Indeed, microbial metabolism is responsible for the heat that radiates from a compost into the environment. A previously mentioned, the metabolism of these meso- and thermophilic microbes is also subject to the aforementioned relationship between temperature and metabolism, which is why thermophilic microbes generally have higher metabolic rates in these higher temperature environments.

This example illustrates microbial fuel cells, which are devices that can generate electricity by harnessing the power of microbial metabolism. Microbial fuel cells (or MFCs) may include two electrodes that are placed in two different environments (although, in some cases, multiple electrodes may be used, e.g., there may be a plurality of anodes and/or cathodes, e.g., in different compartments, which may be operated in series and/or in parallel). For instance, one electrode may be placed in a compartment with an abundance of oxygen (i.e., an aerobic environment), while another electrode may be placed in a second compartment devoid (or at least having a deficient amount) of oxygen (i.e., an anaerobic environment), but with fuel, for example, organic-rich material such as sugars or proteins, biomass, etc. To maintain the electrical potential that exists between the aerobic and anaerobic compartments, the compartments are typically separated by a barrier that prevents the oxygen or at least inhibits from diffusing into the anaerobic compartment, and allows protons or H₂ to move between the compartments to maintain electrical continuity. This proton exchange interface may include, for instance, a synthetic gas-tight polymer membrane that separates the two compartments, or a packed bed that allows electrical continuity but minimizes bulk material mixing.

A wire is attached to each of these electrodes. For instance, a metal wire (e.g. titanium) may be woven along the length of the fabric and retained via a waterproof but conductive epoxy to insure maximum electrical conductivity without enabling electrolysis. The wires from each of these electrodes are then connected to a load, e.g., a light or a motor. Microbes present within each compartment may grow on the electrodes. For example, microbes in the anaerobic compartment may metabolize the organic substrates and transfer electrons from these substrates to the electrode. Because of the difference in electrical potential between these two compartments, the electrons move towards the second electrode. Thus the electrode in the anaerobic environment can be termed the anode, while the electrode in the aerobic (oxygen-rich) environment can be termed the cathode. Once the microbial communities on the anode begin to utilize the anode as a terminal electron acceptor, current is produced and work can be accomplished.

This example illustrates a thermophilic (or “heat loving”) microbial fuel cell that stimulates and sustains higher microbial power production, according to one embodiment of the disclosure. The design of the thermophilic microbial fuel cell of this example may increase the efficiency of power production by harnessing the energy typically lost as heat to stimulate microbial metabolism. Unlike previous systems, this thermophilic fuel cell promotes the growth of anaerobic thermophilic microbes (e.g., bacteria or archaea) that require higher temperatures for their growth and metabolism. Because of their ability to grow at high temperatures, these microbes exhibit high metabolic rates and sustain high power output by the thermophilic fuel cell. Also, the proton exchange interface allows for the rapid evacuation of gases that form as metabolic waste products (such as carbon dioxide and nitrogen) without disrupting the voltage potential. The electrode design of the thermophilic fuel cell of this example may also permit efficient energy production and transfer while also allowing for the elimination of microbial metabolic waste products. For instance, dining prototype tests, the temperatures inside the anode compartment of the thermophilic microbial fuel cell reached 136° F., or 57° C. In one experiment, this temperature remained nearly constant for over four months and showed minimal signs of declining. Power production in the thermophilic microbial fuel cell has also been shown to be 6 to 9 times greater than current systems, and when used with specific fuel compositions, achieved peak power production 12-16 times higher than previously measured.

Microbes have tremendous metabolic capacity, and can break down a wide variety of compounds for energy and growth. However, sustained metabolic activity may require that microbial foodstuffs be abundant and well-balanced (e.g., having abundant carbon, nitrogen, phosphorus and trace minerals, that pH be within reason, and/or that waste products are sufficiently eliminated. In this example, a fuel was used that provides sufficient balanced nutrients for thermophilic microbial activity. This thermophilic fuel was composed of 1 part organic-rich material with abundant organic carbon and nearly equal parts nitrogen, phosphorus and potassium (such as poultry or horse manure, fertilizer grade 3-3-2), 0.1 part alkaline agent such as lime, and 0.1 part electrically conductive substrate such as activated charcoal. When mixed together and used in the anode compartment, the above fuel stimulated and sustained the metabolism and growth of the thermophilic microbes within the fuel cell.

As previously mentioned, microbial metabolic rates are related to the environmental temperature. In many systems where microbial activity is likely to produce heat, including compost piles, sewage treatment plants, and microbial fuel cells, heat is encouraged to dissipate in order to protect the structural integrity of the system (for example, to protect the proton exchange membrane), or to reduce the rate of microbial metabolic activity (such as in a sewage treatment plant). Conversely, this keeps such systems operating at suboptimal temperatures to achieve maximal metabolic rates, e.g., for mesophilic or thermophilic microorganisms. In this example, the fuel cell is able to retain the heat generated from microbial metabolic breakdown of the available fuel. This is accomplished in this example by using a chemically inert, double-walled insulated fuel cell compartment with a minimal surface to volume ratio, for example a spherical glass vacuum flask. Such vacuum-insulated compartments are efficient at retaining heat, with insulating efficiencies up to 95% (meaning just 5% of heat is lost as radiation). This design reduced thermal losses relative to prior fuel cell designs, promoting high microbial metabolic activity by thermophilic microbes. The inert material also may reduce the possibility of leaching toxics from the fuel cell body into the fuel. This fuel cell can use solid or semi-solid fuel in the anode compartment, and liquid or solid fuel in the cathode compartment. Refreshing the anode compartment fuel may occur, for instance, through two gastight ports-mounted opposite one another that enable the user to exhaust the spent fuel through one port and replenish the fuel cell with fresh fuel through the other port as necessary. As previously mentioned, specific fuel blends can be used to stimulate and sustain the metabolism and growth of thermophilic microbes in the present fuel cell, and this may lead to higher heat production, which can further stimulate microbial metabolism. Thus microbial fuel cell efficiency may be increased by harnessing energy lost as heat to do additional work.

As previously mentioned, there are certain limitations when using a proton exchange membrane to separate the anode and cathode compartments of a fuel cell. Also, with respect to a thermophilic fuel cell, metabolic activity can lead to the production of gaseous waste products. These are addressed in this example fuel cell using a packed-bed proton exchange interface. This interface comprised an insulating material bed, e.g., quartz sand with a nominal diameter of 150 to 300 microns, sandwiched between two fiberglass mesh screens. A 1 centimeter thick uniform packed bead bed, with 100 micron zirconium beads sandwiched between two fiberglass mesh screens, has also been tested and proven to be very effective as a proton exchange interface. The thickness of the entire assembly was on the order of one to several centimeters (pending the size of the fuel cell compartments). This interface enabled more rapid proton exchange (to maintain charge balance) while keeping the anode chamber reasonably anoxic and maintaining the electrical potential. It also permits the escape of gaseous products in the anode chamber.

The electrodes used in this fuel cell were designed to be capable of withstanding higher operating temperatures. The electrodes also had a relatively high surface area to sustain electron transport and reduce diffusions distances, and were gas permeable to avoid trapping gaseous waste products that can arise from microbial metabolism. The electrodes were composed of laminate sheets of an inert material (such as carbon fiber or woven titanium) with a mesh size that does not hinder mass transport of metabolites to the electrode surface (e.g., from hundred of micrometers to millimeters). Wires were attached to the electrodes at multiple points via corrosion-resistant fasteners to reduce resistive losses, or were bound to the full length of the electrode by waterproof conductive epoxy. Multiple layers were laid horizontally within the anode chamber, sandwiched within the fuel. These electrodes not only efficiently conduct current, but were designed to increase surface area for electron transport, act as channels to promote horizontal mass and energy flow to insure that dead zones within the anode fuel chamber are reduced or eliminated, and be gas permeable to permit the escape of metabolic waste gasses.

In conclusion, this thermophilic microbial fuel cell was designed to optimize power production by using microbial heat to stimulate microbial metabolic rates. Furthermore, this was able to sustain high microbial metabolic rates, and consequently energy production, e.g., by reducing the limitations attributable to limitations in nutrients or buildup of end products. This system has numerous potential applications in a variety of industries. For example, thermophilic fuel cell designs can be used to boost power output in nearly all microbial fuel cell applications to date. For instance, thermophilic microbial fuel cell designs may be employed by livestock farms to increase power output from manure piles, yielding sufficient power for security lighting or water pumps. Thermophilic microbial fuel cell designs may be used to provide ample power to security or environmental sensors in remote locations. Furthermore, they may be used to generate power for people living off the electrical grid in developing countries. For instance, a thermophilic fuel cell could produce enough power to illuminate several rooms, recharge cell phones, or power radios and low-power computers.

### Example 2

This example describes a microbial energy generator that stimulates and sustains microbial metabolism (of naturally occurring microbes) to catabolize organic compounds in a variety of substrates (including but not limited to agricultural plant waste, livestock waste, food scraps, natural leaf litter, and a variety of soils). The by-product of this process is electricity, which is harnessed by an inert conductive plate or fabric, which may used as an anode. This system allowed continuous operation of this energy generator in an open or closed configuration, enabling energy production while stationary or during transit, depending upon the user's requirements.

The system also, in various embodiments, stimulated the growth of a diverse and previously unidentified assemblage of microbes from anoxic or anaerobic sediments that contributed to power production by producing their own electron mediators and/or electrically conductors (e.g., nanowires or pili); enabled the sustained operation of this device in a wide array of climatological conditions and using a variety of fuels by determining the optimal voltage potential between the anode and cathode for each fuel type and, in some cases, by cycling between load and open circuit states in sequential microbial fuel cells (i.e., “load balancing”); enabled efficient harnessing and storage of microbial energy through the use of an energy storage and management system; and/or allowed the user to operate the microbial fuel cell in an open or closed system, permitting the microbial fuel cell to be used in portable applications.

The devices in this example were modular, and each device could be configured to produce up to between about 0.1 kW yr and 5 kW yr. This may be sufficient to provide power for numerous applications, including devices that can operate directly off microbial fuel cells energy, or those requiring peak power made available through the use of the energy storage and management system of this example. The devices shown here were also scalable, allowing each system to be integrated in a variety of configurations.

This example illustrates a microbial fuel cell, which is a device that can generate electricity by harnessing the power of microbial metabolism. Microbial fuel cells (or MFCs) may include two electrodes that are placed in two different environments (although, in some cases, multiple electrodes may be used, e.g., there may be a plurality of anodes and/or cathodes, e.g., in different compartments, which may be operated in series and/or in parallel). For instance, one electrode may be placed in a compartment with an abundance of oxygen (i.e., an aerobic environment), while another electrode may be placed in a second compartment devoid (or at least having a deficient amount) of oxygen (i.e., an anaerobic environment), but with fuel, for example, organic-rich material such as sugars or proteins, biomass, etc. To maintain the electrical potential that exists between the aerobic and anaerobic compartments, the compartments are typically separated by a barrier that prevents the oxygen or at least inhibits from diffusing into the anaerobic compartment, and allows protons or H₂ to move between the compartments to maintain electrical continuity. This proton exchange interface may include, for instance, a synthetic gas-tight polymer membrane that separates the two compartments.

A wire from each of these electrodes is then connected to a load, e.g., a light or a motor. Microbes present within each compartment may grow on the electrodes. For example, microbes in the anaerobic compartment may metabolize the organic substrates and transfer electrons from these substrates to the electrode. Because of the difference in electrical potential between these two compartments, the electrons move towards the second electrode. Thus the electrode in the anaerobic environment can be termed the anode, while the electrode in the aerobic (oxygen-rich) environment can be termed the cathode. Once the microbial communities on the anode begin to utilize the anode as a terminal electron acceptor, current is produced and work can be accomplished.

One aspect of the microbial fuel cell includes the use of inert conductive flexible surfaces (e.g. graphite cloth, carbon fiber cloth, carbon fiber impregnated cloth, graphite paper, etc) as the anode and cathode (in lieu of solid graphite electrodes), or using conductive coatings (such as powder coatings or “graphite paint”) to create an inert conductive electrode, e.g., on a structural element, such as the fuel cell housing, etc. Graphite may be used to harness microbial metabolic energy. The use of inert conductive flexible surfaces, such as carbon fiber cloth or graphite paper, allows an increase in the reactive electrode surface area without increasing the weight or cost. In some cases, these flexible electrodes are relatively porous, as they typically are formed from laminate sheets with a mesh size from hundred of microns to millimeters. This design does not hinder mass transport of metabolites to the electrode surface as readily as solid electrodes. These flexible conductors also enable relatively lighter fuel cells.

In some cases, the fuel cell of this example has been shown to be effective at harnessing energy through the use of conductive coatings or paints. Fuel cell anodes and cathodes may be prepared by coating a variety of materials (including, but not limited to, metals as well as non-conductive polymers and ceramics) with graphite paint (e.g., a suspension of 20 to 60% graphite in a volatile solvent with an adhesive). A wire may be affixed to the surface prior to coating for adequate conductivity between the lead wire and the electrode surface. In some tests, aluminum, PVC, and glass were coated with graphite paint. Continuous power production per unit surface area in these tests were substantially identical to graphite. Thus, any material amenable to being painted with graphite could serve as a large surface area electrode. In addition, an inert conductive electrode can be created, in some cases, on structural elements of a fuel cell, e.g., an open or closed system microbial fuel cell, such as the MFC housing, the plates underlying a septic leach field, etc.

In addition, this example also shows that pre-treatment of the electrodes (e.g., flexible conductors or graphite coated surfaces) can promote the growth of naturally occurring microbial communities, including populations capable of breaking down complex organic carbon on the anode. For example, the growth of large or diverse microbial communities that have been previously unknown to contribute to power production can be grown. For example, in some experiments, the anodes were treated by soaking them in 0.01 M phosphoric acid at 37° C. overnight. The anodes were removed from the acid bath, rinsed briefly with distilled water and placed into a dry bath of yeast extract and ammonium nitrate (10:1 ratio), followed by exposure to a fuel that was likely to be used with the fuel cell (e.g. livestock waste). Powdered compost can readily be substituted for this treatment, in some cases. This approach was believed to facilitated the rapid growth of energy-generating biofilms on the anode by reducing the oxidation at the graphite surface, and providing readily available substrates for growth as well as an inoculum from the fuel of interest.

To further stimulate power production, the cathode was soaked in 0.5 mM sodium nitrate overnight, then the cathode was vapor-deposited with platinum prior to use. These treatments have been shown to produce up to 34% higher power outputs from the fuel cell for up to one year. Specifically, these treatments appeared to stimulate microbes to produce their own electron shuttles (or biological mediators) that enable to them better transport electrons for purposes such as the extracellular catabolism of refractory organic carbon, or the shuttling of electrons to the anode.

In addition, it was observed that these treatments stimulated the formation of extracellular appendages that directly conduct electricity to the anode. These appendages, pili or “nanowires” have been previously described in three species of laboratory microorganisms (specifically, many phylotypes within the microbial community). However, this treatment appeared to stimulate their growth in microorganisms that were not known to produce these electron-conducting appendages.

The improvements discussed above, relative to electrode materials and treatments, as well as the energy management and storage system, were found to be effective in improving power production and enabling a wider variety of devices to be used with an open fuel cell, i.e., a fuel cell deployed in nature without containment. However, in other experiments, a closed system, contained within a vessel, was used. Closed systems may be portable or scalable, and closed systems can be configured to operate in serial as well as parallel.

The anode compartment was formed from non-conductive, lightweight materials in this example, including but not limited to PVC, polyethylene, polypropylene, and PETE, or more insulating materials such as ceramics, blown glass, or even wood. These materials encourage heat retention in anode chamber (see Example 1) and may be non-reactive with the metabolic by-products such as hydrogen sulfide. To enable a closed system fuel cell to operate more effectively, a system was designed that reduces the effects of self-passivation. In particular, a gas-purging system was designed that directs gaseous by-products past the cathode compartment while still allowing for electrical conductivity between the two compartment through a gas relief system. The interface also acted as a proton exchange barrier.

In some cases, the system may be equipped with a very low cracking pressure check valve that allows gas to escape the anode compartment while reducing the introduction of atmospheric gases from the anode compartment. The gas purging system, in this example, is nested within the packed bed proton exchange interface. The interface includes an insulating material bed made of quartz sand with a nominal diameter of 150 to 300 microns, sandwiched between two fiberglass mesh screens, or of a zirconium particle bed, with 100 micron particles. The thickness of the entire assembly is on the order of several centimeters (based on the size of the fuel cell chambers). This interface enables more rapid proton exchange (to maintain charge balance) while keeping the anode chamber relatively anoxic and maintaining electrical potential.

Microbes have tremendous metabolic capacity, and can break down a wide variety of compounds for energy and growth. However, sustained metabolic activity may require that microbial foodstuffs be abundant and well-balanced (e.g., having abundant carbon, nitrogen, phosphorus and trace minerals), that pH be within reason, and/or that waste products are sufficiently eliminated. In this example, the fuel was supplemented with nitrogen sources including ammonium, nitrate, nitrite, and/or free amino acids, which may stimulate or sustain power production by the fuel cell. This may be due to the role of nitrogenous compounds in biosynthesis of molecules, including but not limited to extracellular polysaccharides, pili, or “nanowires.” In some experiments, increases of 12% to 16% over time were seen due to the addition of nitrogenous compounds.

The fuel cell may also be configured to maintain an empirically derived voltage potential between the anode and the cathode. Specifically, a variety of fuels were tested, including soils from both urban and rural areas located in different climatological regimes (e.g. California and Massachusetts). Also tested in various experiments were food scraps, lawn and garden clippings, dog feces, bird feces, composted livestock waste, and untreated poultry waste. Each fuel was found to produce an optimal power output at a given voltage potential. For example, for some of the fuels listed above, the potential was empirically determined to be between about 0.23 V and about 0.65 V. Thus, the energy management and storage system of this example was designed to include the capacity to set the optimal voltage potential between the anode and cathode for a particular fuel.

Net power production of the fuel cell can also be stimulated by agitation, sharp increases in carbon, etc. In some cases, net power production can also be increased by allowing a fuel cell to “rest” for a length of time. The amount of time may vary as a function of temperature, diffusivity of the fuel, size of the anode, etc. Thus, a simple timing circuit may be used in some cases that uses predetermined time intervals to switch between multiple fuel cells. These fuel cells may be in open or closed system, or some combination thereof. A fuel cell may be allowed to rest while other fuel cells provide power to the energy management and storage system. When MFCs are cycled or “load balanced” in this manner, instantaneous power output can increase by as much as 900%, resulting in net power output gains of approximately 40% to 120%.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1-169. (canceled)

170. An energy management apparatus for at least one microbial fuel cell, the apparatus comprising:
at least one first energy storage component or load to store first energy provided by the at least one microbial fuel cell; and
a comparator circuit, coupled to the at least one first energy storage component or load, to compare a first voltage across the at least one first energy storage component or load to a first set point, the comparator circuit configured to implement a hysteresis window defined by a first predetermined level above the first set point and a second predetermined level below the first set point, such that an output of the comparator circuit changes from a first logic state to a second logic state when the first voltage is at or above the first predetermined level, and the output of the comparator circuit changes from the second logic state to the first logic state when the first voltage is at or below the second predetermined level.

171. The energy management apparatus of claim 170, further comprising:
a voltage conversion circuit, coupled to the comparator circuit, to convert the first voltage to a second voltage higher than the first voltage, the voltage conversion circuit being activated in response to the second logic state and deactivated in response to the first logic state.

172. The energy management apparatus of claim 170, further comprising:
at least one second energy storage component or load, coupled to the voltage conversion circuit, to store second energy provided by the second voltage, wherein the at least one second energy storage component or load provides output power.

173. The apparatus of claim 172, further comprising:
a power supply circuit, coupled to the at least one first energy storage component or load, to provide operating power for at least the comparator circuit and the voltage conversion circuit based only upon the first voltage when the second voltage is insufficient to provide the operating power for at least the comparator circuit and the voltage conversion circuit, wherein the power supply circuit comprises at least one zero-threshold component.

174. The apparatus of claim 172, further comprising at least one battery to provide operating power for at least the comparator circuit and the voltage conversion circuit when the second voltage is insufficient to provide the operating power for at least the comparator circuit and the voltage conversion circuit.

175. The apparatus of claim 171, wherein the voltage conversion circuit comprises:
a step-up transformer including a primary winding and a secondary winding;
a rectifier having a rectifier input coupled to the secondary winding and a rectifier output to provide the second voltage;
an oscillator circuit, coupled to the comparator circuit, to provide an oscillating signal only in response to the second logic state so as to activate the voltage conversion circuit; and
a switching circuit coupled to the oscillator circuit, the at least one first energy storage component or load, and the primary winding of the step-up transformer, the switching circuit applying to the primary winding, in response to the oscillating signal, alternating polarities of the first voltage across the at least one first energy storage component or load.

176. The apparatus of claim 172, further comprising a voltage cutout circuit coupled to the at least one second energy storage component or load to disconnect the at least one second energy storage component or load from out-putting power when the second voltage is at or below a second set point.

177. The apparatus of claim 172, further comprising a voltage feedback circuit coupled to the at least one second energy storage component or load to deactivate the voltage conversion circuit when the second voltage is at or above a third set point.

178. The apparatus of claim 172, wherein the at least one microbial fuel cell includes a plurality of microbial fuel cells, and wherein the apparatus further comprises: a timing circuit to sequentially couple the plurality of microbial fuel cells to the at least one first energy storage component or load.

179. The apparatus of claim 172, further comprising a microprocessor or microcontroller to monitor the first voltage and/or the second voltage.

180. The apparatus of claim 179, wherein the microprocessor further monitors a reference voltage provided by a reference electrode, makes a comparison of the reference voltage and an anode potential and/or a cathode potential associated with the first voltage, and controls the anode potential and/or the cathode potential based at least in part on the comparison.

181. The apparatus of claim 179, wherein the at least one microbial fuel cell includes a plurality of microbial fuel cells, and wherein the apparatus further comprises:
a coupling circuit to couple the plurality of microbial fuel cells to the at least one first energy storage component or load,
wherein the microprocessor controls the coupling circuit so as to sequentially couple the plurality of microbial fuel cells to the at least one first energy storage component or load.

182. The apparatus of claim 181, wherein the microprocessor controls the coupling circuit to couple each microbial fuel cell of the plurality of microbial fuel cells to the at least one first energy storage component or load for a first time period.

183. An energy management method for at least one microbial fuel cell, comprising:
A) intermittently coupling the at least one microbial fuel cell to a load that draws current from the at least one microbial fuel cell.

184. The method of claim 183, wherein A) comprises:
B) coupling the at least one microbial fuel cell to the load for a first time period; and
C) decoupling the at least one microbial fuel cell from the load for a second time period.

185. The method of claim 184, wherein B) comprises:
determining the first time period based at least in part on an instantaneous power output of the at least one microbial fuel cell and a charging rate of at least one first energy storage component of the load to which the at least one microbial fuel cell is coupled in B).

186. The method of claim 184, wherein the at least one microbial fuel cell includes at least a first microbial fuel cell and a second microbial fuel cell, and wherein A) further comprises:
sequentially coupling the first microbial fuel cell and the second microbial fuel cell to the load.

187. The method of claim 186, wherein:
B) comprises coupling the first microbial fuel cell to the load at a first time for the first time period;
C) comprises decoupling the first microbial fuel cell from the load for the second time period, and wherein the method further comprises:
D) coupling the second microbial fuel cell to the load, at a second time different from the first time, for the first time period; and
E) decoupling the second microbial fuel cell from the load for the second time period.

188. An energy management apparatus for at least one microbial fuel cell, the apparatus comprising:
at least one input energy storage device to receive first energy from a cathode and an anode of the at least one microbial fuel cell; and
a switching circuit to intermittently couple the anode and/or the cathode of the at least one microbial fuel cell to a load based at least in part on a voltage potential between the anode and the cathode of the at least one microbial fuel cell.

189. The power management apparatus of claim 188, further comprising at least one output energy storage device to receive second energy from an output of the switching circuit, wherein the at least one output energy storage device provides output power to the load.
